(19) United States
(12) Patent Application Publication
(10) Pub. No.: US 2022/0398156 A1
(43) Pub. Date: Dec. 15, 2022

(54) DISTRIBUTED MULTI-LEVEL PROTECTION IN A HYPER-CONVERGED INFRASTRUCTURE

(71) Applicant: Pure Storage, Inc., Mountain View, CA (US)

(72) Inventors: Ethan L. Miller, Santa Cruz, CA (US); John Colgrove, Los Altos, CA (US); Robert Lee, San Carlos, CA (US)

(21) Appl. No.: 17/876,400

(22) Filed: Jul. 28, 2022

Related U.S. Application Data
(63) Continuation-in-part of application No. 17/172,706, filed on Feb. 10, 2021.
Application No. 17/172,706 is a continuation of application No. 15/917,339, filed on Mar. 9, 2018, now Pat. No. RE48448.
Application No. 15/917,339 is a reissue of application No. 12/896,675, filed on Oct. 1, 2010, now Pat. No. 9,348,696.

(51) Int. Cl. G06F 11/10; G06F 11/30

(52) U.S. Cl. CPC G06F 11/1076; G06F 11/3034; G06F 11/3055; G06F 2211/1057; G06F 2211/1059; H04L 67/1097

(57) ABSTRACT

A storage system includes a plurality of storage nodes. Each storage node of the plurality of storage nodes includes a plurality of non-volatile memory modules. The storage system also includes a processor operatively coupled to the plurality of storage nodes, to perform a method. The method includes receiving incoming data. The method further includes storing the incoming data in a redundant array of independent drives (RAID) stripe in the data storage system. The RAID stripe includes groups of data shards. Each group of data shards and a respective group parity shard are stored across the plurality of nodes of the data storage system. A set of stripe parity shards are stored in a first storage node of the plurality of storage nodes.

### CROSS-REFERENCE TO RELATED APPLICATIONS

This application is a continuation in part of U.S. patent application Ser. No. 17/172,076, filed Feb. 10, 2021, which is a continuation of U.S. patent application Ser. No. 15/917,339, filed Mar. 9, 2018, which is a reissue of U.S. Pat. No. 9,348,696, filed Oct. 1, 2010, the contents of which are incorporated by reference herein.

### FIELD OF THE INVENTION

This invention relates to computer networks and, more particularly, to efficiently distributing data among a plurality of solid-state storage devices.

### DESCRIPTION OF THE RELATED ART

As computer memory storage and data bandwidth increase, so does the amount and complexity of data that businesses daily manage. Large-scale distributed storage systems, such as data centers, typically run many business operations. A distributed storage system may be coupled to client computers interconnected by one or more networks. If any portion of the distributed storage system has poor performance or becomes unavailable, company operations may be impaired or stopped completely. A distributed storage system therefore is expected to maintain high standards for data availability and high-performance functionality. As used herein, storage disks may be referred to as storage devices as some types of storage technologies do not include disks.

To protect against data loss, storage devices often include error detection and correction mechanisms. Often these mechanisms take the form of error correcting codes which are generated by the devices and stored within the devices themselves. In addition, distributed storage systems may also utilize decentralized algorithms to distribute data among a collection of storage devices. These algorithms generally map data objects to storage devices without relying on a central directory. Examples of such algorithms include Replication Under Scalable Hashing (RUSH), and Controlled Replication Under Scalable Hashing (CRUSH). With no central directory, multiple clients in a distributed storage system may simultaneously access data objects on multiple servers. In addition, the amount of stored metadata may be reduced. However, the difficult task remains of distributing data among multiple storage disks with varying capacities, input/output (I/O) characteristics and reliability issues. Similar to the storage devices themselves, these algorithms may also include error detection and correction algorithms such as RAID type algorithms (e.g., RAID5 and RAID6) or Reed-Solomon codes.

The technology and mechanisms associated with chosen storage devices determine the methods used to distribute data among multiple storage devices, which may be dynamically added and removed. For example, the algorithms described above were developed for systems utilizing hard disk drives (HDDs). The HDDs comprise one or more rotating disks, each coated with a magnetic medium. These disks rotate at a rate of several thousand rotations per minute for several hours daily. In addition, a magnetic actuator is responsible for positioning magnetic read/write devices over the rotating disks. These actuators are subject to friction, wear, vibrations and mechanical misalignments, which result in reliability issues. The above-described data distribution algorithms are based upon the characteristics and behaviors of HDDs.

One example of another type of storage disk is a Solid-State Disk (SSD). A Solid-State Disk may also be referred to as a Solid-State Drive. An SSD may emulate a HDD interface, but an SSD utilizes solid-state memory to store persistent data rather than electromechanical devices as found in a HDD. For example, an SSD may comprise banks of Flash memory. Without moving parts or mechanical delays, an SSD may have a lower access time and latency than a HDD. However, SSD typically have significant write latencies. In addition to different input/output (I/O) characteristics, an SSD experiences different failure modes than a HDD. Accordingly, high performance and high reliability may not be achieved in systems comprising SSDs for storage while utilizing distributed data placement algorithms developed for HDDs.

In view of the above, systems and methods for efficiently distributing data and detecting and correcting errors among a plurality of solid-state storage devices are desired.

### SUMMARY OF THE INVENTION

Various embodiments of a computer system and methods for efficiently distributing and managing data among a plurality of solid-state storage devices are disclosed.

In one embodiment, a computer system comprises a plurality of client computers configured to convey read and write requests over a network to one or more data storage arrays coupled to receive the read and write requests via the network. Contemplated is a data storage array(s) comprising a plurality of storage locations on a plurality of storage devices. In various embodiments, the storage devices are configured in a redundant array of independent drives (RAID) arrangement for data storage and protection. The data storage devices may include solid-state memory technology for data storage, such as Flash memory cells. The data storage subsystem further comprises a storage controller configured to configure a first subset of the storage devices for use in a first RAID layout, the first RAID layout including a first set of redundant data. The controller further configures a second subset of the storage devices for use in a second RAID layout, the second RAID layout including a second set of redundant data. Additionally, when writing a stripe, the controller may select from any of the plurality of storage devices for one or more of the first RAID layout, the second RAID layout, and storage of redundant data by the additional logical device.

Also contemplated are embodiments wherein the first RAID layout is an L+x layout, and the second RAID layout is an M+y layout, wherein L, x, M, and, y are integers, wherein either or both (1) L is not equal to M, and (2) x is not equal to y.

These and other embodiments will become apparent upon consideration of the following description and accompanying drawings.

### BRIEF DESCRIPTION OF THE DRAWINGS

FIG. 1 is a generalized block diagram illustrating one embodiment of network architecture.

FIG. 2 is a generalized block diagram of one embodiment of a dynamic intra-device redundancy scheme.

FIG. 3 is a generalized flow diagram illustrating one embodiment of a method for adjusting intra-device protection in a data storage subsystem.

FIG. 4 is a generalized block diagram of one embodiment of a storage subsystem.

FIG. 5 is a generalized block diagram of one embodiment of a device unit.

FIG. 6 is a generalized block diagram illustrating one embodiment of a state table.

FIG. 7 is a generalized block diagram illustrating one embodiment of a flexible RAID data layout architecture.

FIG. 8 is a generalized block diagram illustrating another embodiment of a flexible RAID data layout architecture.

FIG. 9 is a generalized flow diagram illustrating one embodiment of a method for dynamically determining a layout in a data storage subsystem.

FIG. 10 is a generalized block diagram illustrating yet another embodiment of a flexible RAID data layout architecture.

FIG. 11A illustrates one embodiment of a device layout.

FIG. 11B illustrates one embodiment of a segment.

FIG. 11C is a generalized block diagram illustrating one embodiment of data storage arrangements within different page types.

FIG. 12 is a generalized block diagram illustrating one embodiment of a hybrid RAID data layout.

FIG. 13 is a generalized flow diagram illustrating one embodiment of a method for selecting alternate RAID geometries in a data storage subsystem.

FIG. 14A is a perspective view of a storage cluster with multiple storage nodes and internal storage coupled to each storage node to provide network attached storage, in accordance with some embodiments.

FIG. 14B is a block diagram showing an interconnect switch coupling multiple storage nodes in accordance with some embodiments.

FIG. 14C is a multiple level block diagram, showing contents of a storage node and contents of one of the non-volatile solid state storage units in accordance with some embodiments.

FIG. 15A block diagram of a storage system in accordance with some embodiments.

FIG. 15B block diagram of a storage system in accordance with some embodiments.

FIG. 16 is a generalized flow diagram illustrating one embodiment of a method for storing data in a storage system in accordance with some embodiments.

FIG. 17 is a generalized flow diagram illustrating one embodiment of a method 1700 for relocating data shards in a storage system in accordance with some embodiments.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, signals, computer program instruction, and techniques have not been shown in detail to avoid obscuring the present invention.

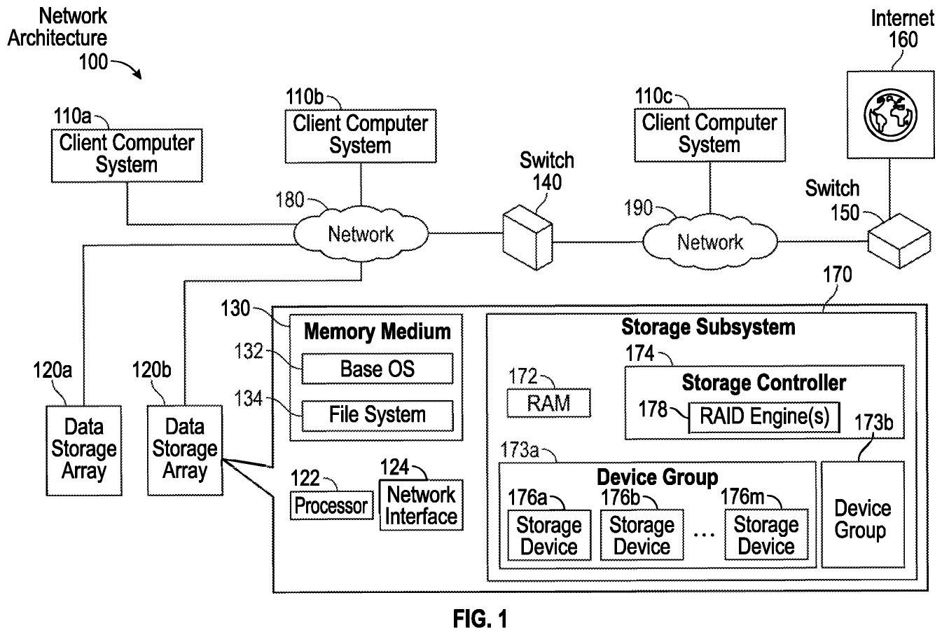

Referring to FIG. 1, a generalized block diagram of one embodiment of network architecture 100 is shown. As described further below, one embodiment of network architecture 100 includes client computer systems 110a-110b interconnected to one another through a network 180 and to data storage arrays 120a-120b. Network 180 may be coupled to a second network 190 through a switch 140. Client computer system 110c is coupled to client computer systems 110a-110b and data storage arrays 120a-120b via network 190. In addition, network 190 may be coupled to the Internet 160 or other outside network through switch 150.

It is noted that in alternative embodiments, the number and type of client computers and servers, switches, networks, data storage arrays, and data storage devices is not limited to those shown in FIG. 1. At various times one or more clients may operate offline. In addition, during operation, individual client computer connection types may change as users connect, disconnect, and reconnect to network architecture 100. A further description of each of the components shown in FIG. 1 is provided shortly. First, an overview of some of the features provided by the data storage arrays 120a-120b is described.

In the network architecture 100, each of the data storage arrays 120a-120b may be used for the sharing of data among different servers and computers, such as client computer systems 110a-110c. In addition, the data storage arrays 120a-120b may be used for disk mirroring, backup and restore, archival and retrieval of archived data, and data migration from one storage device to another. In an alternate embodiment, one or more client computer systems 110a-110c may be linked to one another through fast local area networks (LANs) in order to form a cluster. One or more nodes linked to one another form a cluster, which may share a storage resource, such as a cluster shared volume residing within one of data storage arrays 120a-120b.

Each of the data storage arrays 120a-120b includes a storage subsystem 170 for data storage. Storage subsystem 170 may comprise a plurality of storage devices 176a-176m. These storage devices 176a-176m may provide data storage services to client computer systems 110a-110c. Each of the storage devices 176a-176m may be configured to receive read and write requests and comprise a plurality of data storage locations, each data storage location being addressable as rows and columns in an array. In one embodiment, the data storage locations within the storage devices 176a-176m may be arranged into logical, redundant storage containers or RAID arrays (redundant arrays of inexpensive/independent disks). However, the storage devices 176a-176m may not comprise a disk. In one embodiment, each of the storage devices 176a-176m may utilize technology for data storage that is different from a conventional hard disk drive (HDD). For example, one or more of the storage devices 176a-176m may include or be further coupled to storage consisting of solid-state memory to store persistent data. In other embodiments, one or more of the storage devices 176a-176m may include or be further coupled to storage utilizing spin torque transfer technique, magnetoresistive random access memory (MRAM) technique, or other storage techniques. These different storage techniques may lead to differing reliability characteristics between storage devices.

The type of technology and mechanism used within each of the storage devices 176a-176m may determine the algorithms used for data object mapping and error detection and correction. The logic used in these algorithms may be included within one or more of a base operating system (OS) 116, a file system 140, one or more global RAID engines 178 within a storage subsystem controller 174, and control logic within each of the storage devices 176a-176m.

In one embodiment, the included solid-state memory comprises solid-state drive (SSD) technology. Typically, SSD technology utilizes Flash memory cells. As is well known in the art, a Flash memory cell holds a binary value based on a range of electrons trapped and stored in a floating gate. A fully erased Flash memory cell stores no or a minimal number of electrons in the floating gate. A particular binary value, such as binary 1 for single-level cell (SLC) Flash, is associated with an erased Flash memory cell. A multi-level cell (MLC) Flash has a binary value 11 associated with an erased Flash memory cell. After applying a voltage higher than a given threshold voltage to a controlling gate within a Flash memory cell, the Flash memory cell traps a given range of electrons in the floating gate. Accordingly, another particular binary value, such as binary 0 for SLC Flash, is associated with the programmed (written) Flash memory cell. A MLC Flash cell may have one of multiple binary values associated with the programmed memory cell depending on the applied voltage to the control gate.

Generally speaking, SSD technologies provide lower read access latency times than HDD technologies. However, the write performance of SSDs is significantly impacted by the availability of free, programmable blocks within the SSD. As the write performance of SSDs is significantly slower compared to the read performance of SSDs, problems may occur with certain functions or operations expecting similar latencies. In addition, the differences in technology and mechanisms between HDD technology and SDD technology lead to differences in reliability characteristics of the data storage devices 176a-176m.

In various embodiments, a Flash cell within an SSD must generally be erased before it is written with new data. Additionally, an erase operation in various flash technologies must also be performed on a block-wise basis. Consequently, all of the Flash memory cells within a block (an erase segment or erase block) are erased together. A Flash erase block may comprise multiple pages. For example, a page may be 4 kilobytes (KB) in size and a block may include 64 pages, or 256 KB. Compared to read operations in a Flash device, an erase operation may have a relatively high latency—which may in turn increase the latency of a corresponding write operation. Programming or reading of Flash technologies may be performed at a lower level of granularity than the erase block size. For example, Flash cells may be programmed or read at a byte, word, or other size.

A Flash cell experiences wear after repetitive erase-and-program operations. The wear in this case is due to electric charges that are injected and trapped in the dielectric oxide layer between the substrate and the floating gate of the MLC Flash cell. In one example, a MLC Flash cell may have a limit of a number of times it experiences an erase-and-program operation, such as a range from 10,000 to 100,000 cycles. In addition, SSDs may experience program disturb errors that cause a neighboring or nearby Flash cell to experience an accidental state change while another Flash cell is being erased or programmed. Further, SSDs include read disturb errors, wherein the accidental state change of a nearby Flash cell occurs when another Flash cell is being read.

Knowing the characteristics of each of the one or more storage devices 176a-176m may lead to more efficient data object mapping and error detection and correction. In one embodiment, the global RAID engine 178 within the storage controller 174 may detect for the storage devices 176a-176m at least one or more of the following: inconsistent response times for I/O requests, incorrect data for corresponding accesses, error rates and access rates. In response to at least these characteristics, the global RAID engine 178 may determine which RAID data layout architecture to utilize for a corresponding group of storage devices within storage devices 176a-176m. In addition, the global RAID engine 178 may dynamically change both an intra-device redundancy scheme and an inter-device RAID data layout based on the characteristics of the storage devices 176a-176m.

FIG. 1 illustrates an example of a system capable of the described features according to one embodiment. Further details are provided below. Referring to FIG. 1, a further description of the components of network architecture 100 is provided below.

Components of a Network Architecture

Again, as shown, network architecture 100 includes client computer systems 110a-110c interconnected through networks 180 and 190 to one another and to data storage arrays 120a-120b. Networks 180 and 190 may include a variety of techniques including wireless connection, direct local area network (LAN) connections, storage area networks (SANs), wide area network (WAN) connections such as the Internet, a router, and others. Networks 180 and 190 may comprise one or more LANs that may also be wireless. Networks 180 and 190 may further include remote direct memory access (RDMA) hardware and/or software, transmission control protocol/internet protocol (TCP/IP) hardware and/or software, router, repeaters, switches, grids, and/or others. Protocols such as Ethernet, Fibre Channel, Fibre Channel over Ethernet (FCoE), iSCSI, and so forth may be used in networks 180 and 190. Switch 140 may utilize a protocol associated with both networks 180 and 190. The network 190 may interface with a set of communications protocols used for the Internet 160 such as the Transmission Control Protocol (TCP) and the Internet Protocol (IP), or TCP/IP. Switch 150 may be a TCP/IP switch.

Client computer systems 110a-110c are representative of any number of stationary or mobile computers such as desktop personal computers (PCs), workstations, laptops, handheld computers, servers, server farms, personal digital assistants (PDAs), smart phones, and so forth. Generally speaking, client computer systems 110a-110c include one or more processors comprising one or more processor cores. Each processor core includes circuitry for executing instructions according to a predefined general-purpose instruction set. For example, the x86 instruction set architecture may be selected. Alternatively, the Alpha®, PowerPC®, SPARC®, or any other general-purpose instruction set architecture may be selected. The processor cores may access cache memory subsystems for data and computer program instructions. The cache subsystems may be coupled to a memory hierarchy comprising random access memory (RAM) and a storage device.

Each processor core and memory hierarchy within a client computer system may be in turn connected to a network interface. In addition to hardware components, each of the client computer systems 110a-110c may include a base operating system (OS) stored within the memory hierarchy. The base OS may be representative of any of a variety of specific operating systems, such as, for example, MS-DOS®, MS-WINDOWS®, OS/2®, UNIX®, Linux®, Solaris® or another known operating system. As such, the base OS may be operable to provide various services to the end-user and provide a software framework operable to support the execution of various programs. Additionally, each of the client computer systems 110a-110c may include a hypervisor used to support higher-level virtual machines (VMs). As is well known to those skilled in the art, virtualization may be used in desktops and servers to fully or partially decouple software, such as an OS, from a system's hardware. Virtualization may provide an end-user with an illusion of multiple OSes running on a same machine each having its own resources, such logical storage entities (e.g., logical unit numbers, LUNs) corresponding to the storage devices 176a-176m within each of the data storage arrays 120a-120b.

Each of the data storage arrays 120a-120b may be used for the sharing of data among different servers, such as the client computer systems 110a-110c. Each of the data storage arrays 120a-120b includes a storage subsystem 170 for data storage. Storage subsystem 170 may comprise a plurality of storage devices 176a-176m. Each of these storage devices 176a-176m may be a SSD. A controller 174 may comprise logic for handling received read/write requests. For example, the algorithms briefly described above may be executed in at least controller 174. A random-access memory (RAM) 172 may be used to batch operations, such as received write requests.

The base OS 132, the file system 134, any OS drivers (not shown) and other software stored in memory medium 130 may provide functionality enabling access to files and LUNs, and the management of these functionalities. The base OS 134 and the OS drivers may comprise program instructions stored on the memory medium 130 and executable by processor 122 to perform one or more memory access operations in storage subsystem 170 that correspond to received requests.

Each of the data storage arrays 120a-120b may use a network interface 124 to connect to network 180. Similar to client computer systems 110a-110c, in one embodiment, the functionality of network interface 124 may be included on a network adapter card. The functionality of network interface 124 may be implemented using both hardware and software. Both a random-access memory (RAM) and a read-only memory (ROM) may be included on a network card implementation of network interface 124. One or more application specific integrated circuits (ASICs) may be used to provide the functionality of network interface 124.

In one embodiment, a data storage model may be developed which seeks to optimize data layouts for both user data and corresponding error correction code (ECC) information. In one embodiment, the model is based at least in part on characteristics of the storage devices within a storage system. For example, in a storage system, which utilizes solid-state storage technologies, characteristics of the particular devices may be used to develop a model for the storage system and may also serve to inform corresponding data storage arrangement algorithms. For example, if particular storage devices being used exhibit a change in reliability over time, such a characteristic may be accounted for in dynamically changing a data storage arrangement.

Generally speaking, any model which is developed for a computing system is incomplete. Often, there are simply too many variables to account for in a real world system to completely model a given system. In some cases, it may be possible to develop models which are not complete but which are nevertheless valuable. As discussed more fully below, embodiments are described wherein a storage system is modeled based upon characteristics of the underlying devices. In various embodiments, selecting a data storage arrangement is performed based on certain predictions as to how the system may behave. Based upon an understanding of the characteristics of the devices, certain device behaviors are more predictable than others. However, device behaviors may change over time, and in response, a selected data layout may also be changed. As used herein, characteristics of a device may refer to characteristics of the device as a whole, characteristics of a sub-portion of a device such as a chip or other component, characteristics of an erase block, or any other characteristics related to the device.

Intra-Device Redundancy

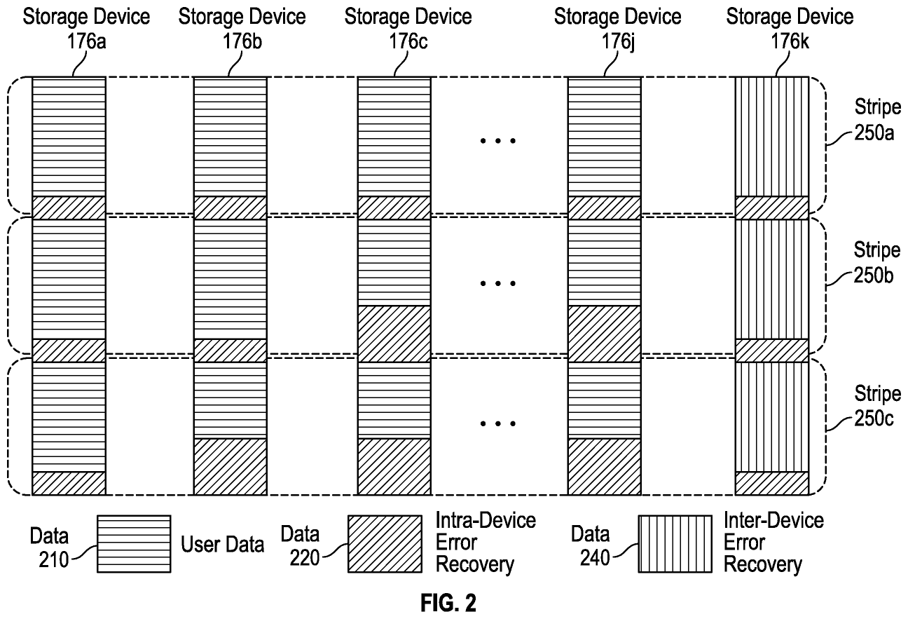

Turning now to FIG. 2, a generalized block diagram illustrating one embodiment of a dynamic intra-device redundancy scheme is shown. As is well known to those skilled in the art, one of several intra-device redundancy schemes may be chosen to reduce the effects of latent sector errors in a storage device. The term “sector” typically refers to a basic unit of storage on a HDD, such as a segment within a given track on the disk. Here, the term “sector” may also refer to a basic unit of allocation on a SSD.

An allocation unit within an SSD may include one or more erase blocks within an SSD. Referring to FIG. 2, the user data 210 may refer to both stored data to be modified and accessed by end-users and inter-device error-correction code (ECC) data. The inter-device ECC data may be parity information generated from one or more pages on other storage devices holding user data. For example, the inter-device ECC data may be parity information used in a RAID data layout architecture. The user data 210 may be stored within one or more pages included within one or more of the storage devices 176a-176k. In one embodiment, each of the storage devices 176a-176k is an SSD.

An erase block within an SSD may comprise several pages. As described earlier, in one embodiment, a page may include 4 KB of data storage space. An erase block may include 64 pages, or 256 KB. In other embodiments, an erase block may be as large as 1 megabyte (MB), and include 256 pages. An allocation unit size may be chosen in a manner to provide both sufficiently large sized units and a relatively low number of units to reduce overhead tracking of the allocation units. In one embodiment, one or more state tables may maintain a state of an allocation unit (allocated, free, erased, error), a wear level, and a count of a number of errors (correctable and/or uncorrectable) that have occurred within the allocation unit. In various embodiments, the size of an allocation unit may be selected to balance the number of allocation units available for a give device against the overhead of maintaining the allocation units. For example, in one embodiment the size of an allocation unit may be selected to be approximately 1/100th of one percent of the total storage capacity of an SSD. Other amounts of data storage space for pages, erase blocks and other unit arrangements are possible and contemplated.

Latent sector errors (LSEs) occur when a given sector or other storage unit within a storage device is inaccessible. A read or write operation may not be able to complete for the given sector. In addition, there may be an uncorrectable error-correction code (ECC) error. An LSE is an error that is undetected until the given sector is accessed. Therefore, any data previously stored in the given sector may be lost. A single LSE may lead to data loss when encountered during RAID reconstruction after a storage device failure. For an SSD, an increase in the probability of an occurrence of another LSE may result from at least one of the following statistics: device age, device size, access rates, storage compactness and the occurrence of previous correctable and uncorrectable errors. To protect against LSEs and data loss within a given storage device, one of a multiple of intra-device redundancy schemes may be used within the given storage device.

An intra-device redundancy scheme utilizes ECC information, such as parity information, within the given storage device. This intra-device redundancy scheme and its ECC information corresponds to a given device and may be maintained within a given device, but is distinct from ECC that may be internally generated and maintained by the device itself. Generally speaking, the internally generated and maintained ECC of the device is invisible to the system within which the device is included. The intra-device ECC information included within the given storage device may be used to increase data storage reliability within the given storage device. This intra-device ECC information is in addition to other ECC information that may be included within another storage device such as parity information utilized in a RAID data layout architecture.

A highly effective intra-device redundancy scheme may sufficiently enhance a reliability of a given RAID data layout to cause a reduction in a number of devices used to hold parity information. For example, a double parity RAID layout may be replaced with a single parity RAID layout if there is additional intra-device redundancy to protect the data on each device. For a fixed degree of storage efficiency, increasing the redundancy in an intra-device redundancy scheme increases the reliability of the given storage device. However, increasing the redundancy in such a manner may also increase a penalty on the input/output (I/O) performance of the given storage device. 1005511n one embodiment, an intra-device redundancy scheme divides a device into groups of locations for storage of user data. For example, a division may be a group of locations within a device that correspond to a stripe within a RAID layout as shown by stripes 250a-250c. User data or inter-device RAID redundancy information may be stored in one or more pages within each of the storage devices 176a-176k as shown by data 210. Within each storage device, intra-device error recovery data 220 may be stored in one or more pages. As used herein, the intra-device error recovery data 220 may be referred to as intra-device redundancy data 220. As is well known by those skilled in the art, the intra-device redundancy data 220 may be obtained by performing a function on chosen bits of information within the data 210. An XOR-based operation may be used to derive parity information to store in the intra-device redundancy data 220. Other examples of intra-device redundancy schemes include single parity check (SPC), maximum distance separable (MDS) erasure codes, interleaved parity check codes (IPC), hybrid SPC and MDS code (MDS+SPC), and column diagonal parity (CDP). The schemes vary in terms of delivered reliability and overhead depending on the manner the data 220 is computed. In addition to the above described redundancy information, the system may be configured to calculate a checksum value for a region on the device. For example, a checksum may be calculated when information is written to the device. This checksum is stored by the system. When the information is read back from the device, the system may calculate the checksum again and compare it to the value that was stored originally. If the two checksums differ, the information was not read properly, and the system may use other schemes to recover the data. Examples of checksum functions include cyclical redundancy check (CRC), MD5, and SHA-1.

As shown in stripes 250a-250c, the width, or number of pages, used to store the data 210 within a given stripe may be the same in each of the storage devices 176a-176k. However, as shown in stripes 250b-250c, the width, or number of pages, used to store the intra-device redundancy data 220 within a given stripe may not be the same in each of the storage devices 176a-176k. In one embodiment, changing characteristics or behaviors of a given storage device may determine, at least in part, the width used to store corresponding intra-device redundancy data 220. For example, as described above, Flash cells experience program disturb errors and read disturb errors, wherein programming or reading a page may disturb nearby pages and cause errors within these nearby pages. When a storage device is aging and producing more errors, the amount of corresponding intra-device redundancy data 220 may increase. For example, prior to a write operation for stripe 250b, characteristics of each of the storage devices 176a-176k may be monitored and used to predict an increasing error rate. A predicted increase in errors for storage devices 176c and 176j may be detected. In response, the amount of intra-device redundancy data 220 may be increased for storage devices 176c and 176j. In the example of stripes 250a and 250b of FIG. 2, an increase in the amount of protection data stored can be seen for storage devices 176c and 176j for stripes 250a and 250b. For example, now, rather than protecting storage devices 176c and 176j with single parity, these devices may be protected with double parity or triple parity. It is noted that increasing the amount of intra-device protection for devices 176c and 176j does not necessitate a corresponding increase in other devices of the same stripe. Rather, data for the stripe may have differing levels of protection in each device as desired.

In various embodiments, increases or decreases in a given level of data protection may occur on a selective basis. For example, in one embodiment, an increase in protection may occur only for storage devices that are detected to generate more errors, such as storage devices 176c and 176j in the above example. In another embodiment, an increase in protection may occur for each of the storage devices 176a-176k when storage devices 176c and 176j are detected to generate more errors. In one embodiment, increasing the amount of intra-device protection on a parity device such as device 176k may require a reduction in the amount of data protected within the stripe. For example, increasing the amount of intra-device data stored on a parity device for a given stripe will necessarily reduce an amount of parity data stored by that device for data within the stripe. If this amount of parity data is reduced to an amount that is less than that needed to protect all of the data in the stripe, then data within the stripe must be reduced if continued parity protection is desired. As an alternative to reducing an amount of data stored within the stripe, a different device could be selected for storing the parity data. Various options are possible and are contemplated. It is also noted that while FIG. 2 and other figures described herein may depict a distinct parity device (e.g., 176k), in various embodiments the parity may be distributed across multiple devices rather than stored in a single device. Accordingly, the depiction of a separate parity device in the figures may generally be considered a logical depiction for ease of discussion.

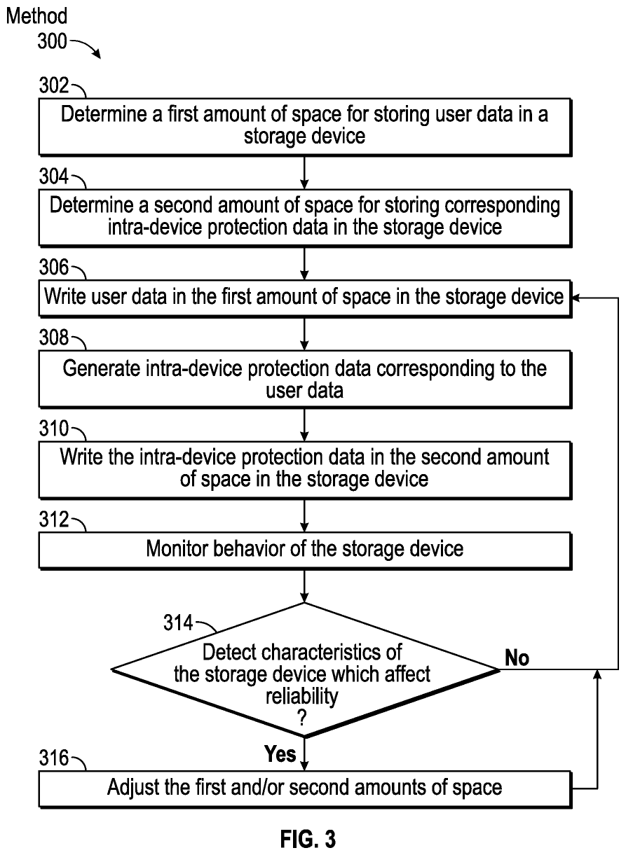

Referring now to FIG. 3, one embodiment of a method 300 for adjusting intra-device protection in a data storage subsystem is shown. The components embodied in network architecture 100 and data storage arrays 120a-120b described above may generally operate in accordance with method 300. The steps in this embodiment are shown in sequential order. However, some steps may occur in a different order than shown, some steps may be performed concurrently, some steps may be combined with other steps, and some steps may be absent in another embodiment.

In block 302, a first amount of space for storing user data in a storage device is determined. This user data may be data used in end-user applications or inter-device parity information used in a RAID architecture as described earlier regarding data 210. This first amount of space may comprise one or more pages within a storage device as described earlier. In one embodiment, a global RAID engine 178 within the storage controller 174 receives behavioral statistics from each one of the storage devices 176a-176m. For a given device group comprising two or more of the storage devices 176a-176m, the global RAID engine 178 may determine both a RAID data layout and an initial amount of intra-device redundancy to maintain within each of the two or more storage devices. In block 304, the RAID engine 178 may determine a second amount of space for storing corresponding intra-device protection data in a storage device. This second amount of space may comprise one or more pages within a storage device. The intra-device protection data may correspond to the intra-device redundancy data 220 described earlier.

In block 306, data is written in the first amount of space within each storage device included within a given device group. In one embodiment, both user data and inter-device parity information is written as a single RAID stripe across multiple storage devices included within the given device group. Referring again to FIG. 2, the width for the corresponding data being written is the same within each storage device. In block 308, the intra-device protection data is generated by an ECC algorithm, an XOR-based algorithm, or any other suitable algorithm. In addition, the system may generate a checksum to help identify data that has not been retrieved properly. In block 310, the generated intra-device protection data is written in the second amount of space in the storage devices.

In block 312, the RAID engine 178 may monitor behavior of the one or more storage devices. In one embodiment, the RAID engine 178 may include a model of a corresponding storage device and receive behavioral statistics from the storage device to input to the model. The model may predict behavior of the storage device by utilizing known characteristics of the storage device. For example, the model may predict an upcoming increasing error rate for a given storage device. If the RAID engine 178 detects characteristics of a given storage device which affect reliability (conditional block 314), then in block 316, the RAID engine may adjust the first amount and the second amount of space for storing data and corresponding intra-device redundancy data. For example, the RAID engine may be monitoring the statistics described earlier such as at least device age, access rate and error rate. Referring again to FIG. 2, the RAID engine 178 may detect storage devices 176c and 176j have an increase in a number of errors. Alternatively, the RAID engine may predict an increase in a number of errors for storage devices 176c and 176j. Accordingly, prior to writing the second stripe 250b, the RAID engine 178 may adjust a number of pages used to store data 210 and data 220 in each of the storage devices 176a-176k. Similarly, the RAID engine 178 may detect storage device 176b has decreased reliability. Therefore, prior to writing the third stripe 250c, the RAID engine 178 may again adjust a number of pages used to store data 210 and data 220 in each of the storage devices 176a-176k.

Monitoring Storage Device Characteristics

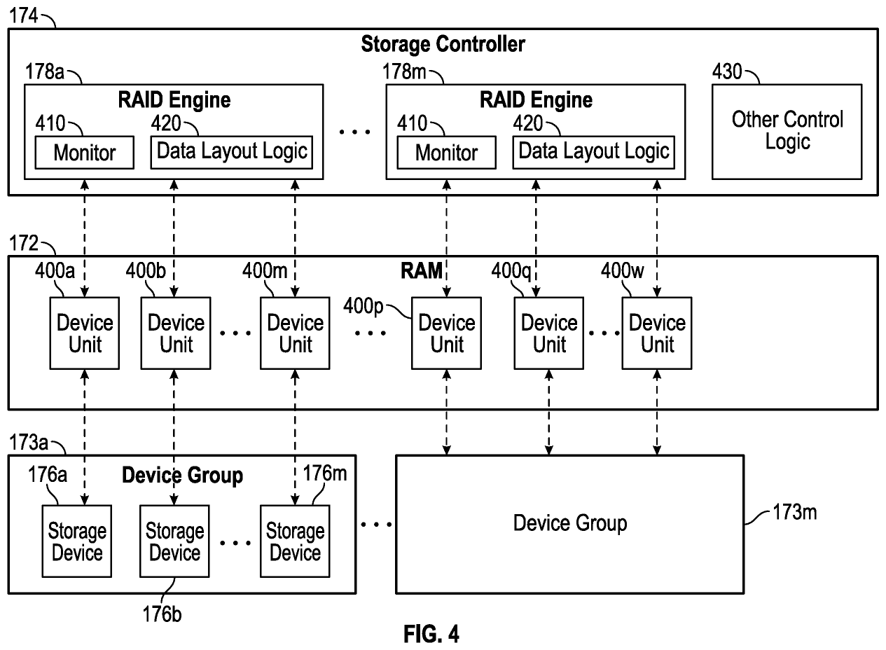

Turning now to FIG. 4, a generalized block diagram of one embodiment of a storage subsystem is shown. Each of the one or more storage devices 176a-176m may be partitioned in one of one or more device groups 173a-173m. Other device groups with other devices may be present as well. One or more corresponding operation queues and status tables for each storage device may be included in one of the device units 400a-400w. These device units may be stored in RAM 172. A corresponding RAID engine 178a-178m may be included for each one of the device groups 173a-173m. Each RAID engine 178 may include a monitor 410 that tracks statistics for each of the storage devices included within a corresponding device group. Data layout logic 420 may determine an amount of space to allocate within a corresponding storage device for user data, inter-device redundancy data and intra-device redundancy data. The storage controller 174 may comprise other control logic 430 to perform at least one of the following tasks: wear leveling, garbage collection, I/O scheduling, deduplication and protocol conversion for incoming and outgoing packets.

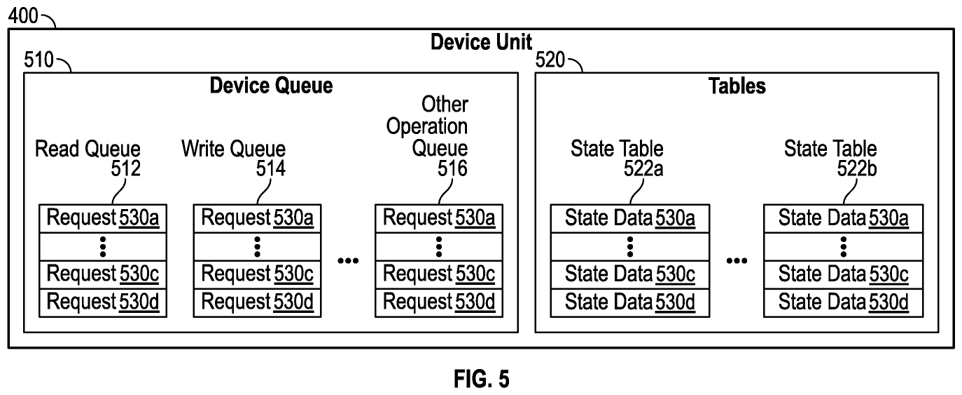

Turning now to FIG. 5, a generalized block diagram of one embodiment of a device unit is shown. A device unit may comprise a device queue 510 and tables 520. Device queue 510 may include a read queue 512, a write queue 514 and one or more other queues such as other operation queue 516. Each queue may comprise a plurality of entries for storing one or more corresponding requests 530a-530d. For example, a device unit for a corresponding SSD may include queues to store at least read requests, write requests, trim requests, erase requests and so forth. Tables 520 may comprise one or more state tables 522a-522b, each comprising a plurality of entries for storing state data, or statistics, 530. It is also noted that while the queues and tables are shown to include a particular number of entries in this and other figures, the entries themselves do not necessarily correspond to one another. Additionally, the number of queues, tables, and entries may vary from that shown in the figure and may differ from one another.

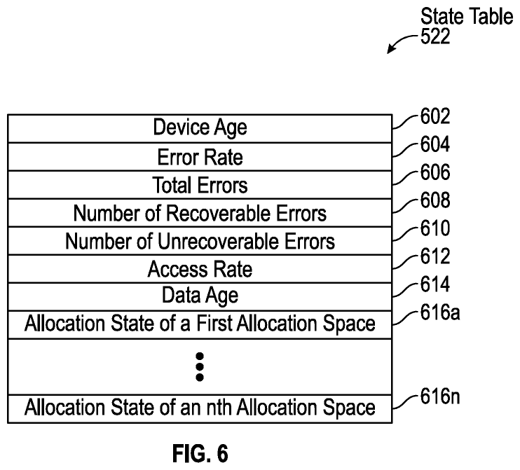

Referring now to FIG. 6, a generalized block diagram illustrating one embodiment of a state table corresponding to a given device is shown. In one embodiment, such a table may include data corresponding to state, error and wear level information for a given storage device, such as an SSD. A corresponding RAID engine may have access to this information, which may allow the RAID engine to dynamically change space allocated for data storage and schemes used for both inter-device protection and intra-device protection. In one embodiment, the information may include at least one or more of a device age 602, an error rate 604, a total number of errors detected on the device 606, a number of recoverable errors 608, a number of unrecoverable errors 610, an access rate of the device 612, an age of the data stored 614 and one or more allocation states for allocation spaces 616a-616n. The allocation states may include filled, empty, error and so forth.

Flexible RAID Layout

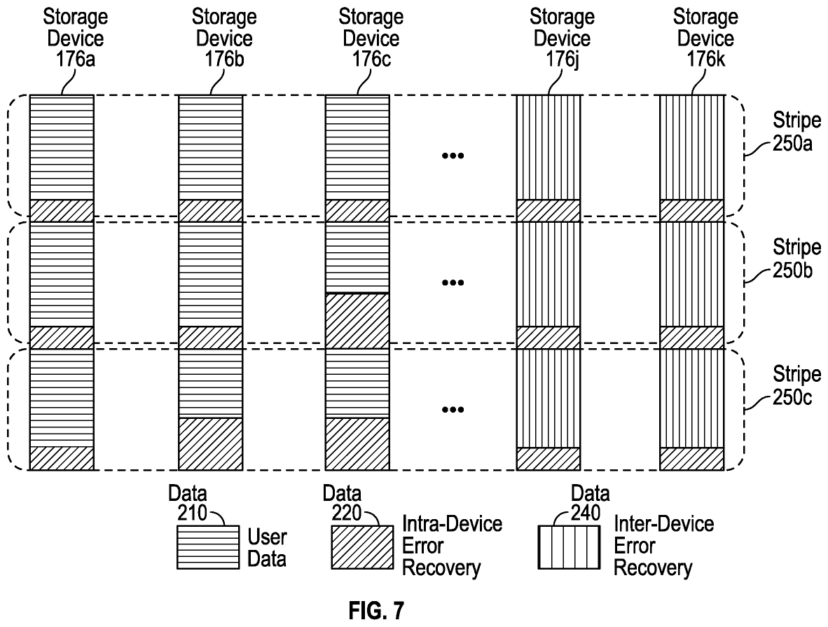

Turning now to FIG. 7, a generalized block diagram illustrating one embodiment of a flexible RAID data layout architecture is shown. A RAID engine may determine a level of protection to use for storage devices 176a-176k. For example, a RAID engine may determine to utilize RAID double parity for the storage devices 176a-176k. The inter-device redundancy data 240 may represent the RAID double parity values generated from corresponding user data. In one embodiment, storage devices 176j and 176k may store the double parity information. It is understood other levels of RAID parity protection are possible and contemplated. In addition, in other embodiments, the storage of the double parity information may rotate between the storage devices rather than be stored within storage devices 176j and 176k for each RAID stripe. The storage of the double parity information is shown to be stored in storage devices 176j and 176k for ease of illustration and description.

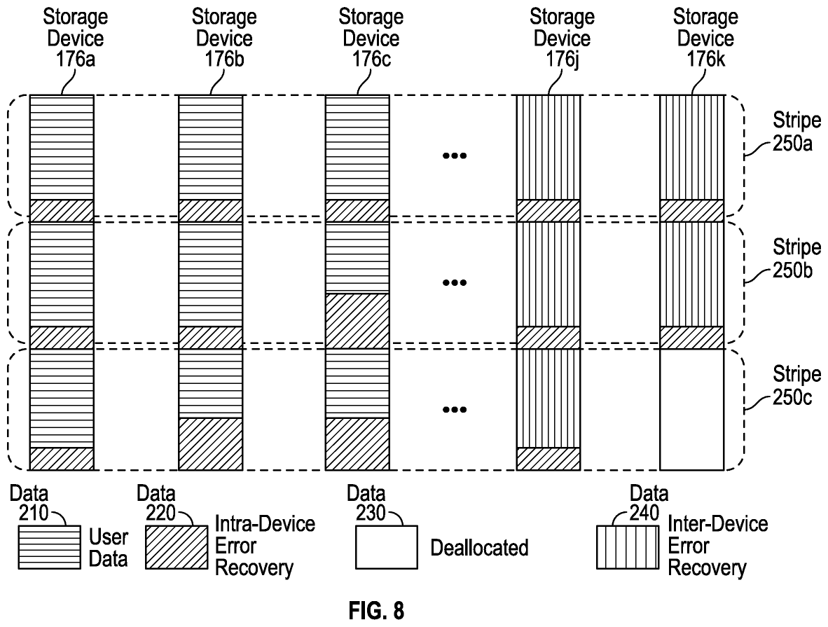

Referring now to FIG. 8, a generalized block diagram illustrating another embodiment of a flexible RAID data layout architecture is shown. Similar to the example shown in FIG. 7, double parity may be used for the storage devices 176a-176k. Although a RAID double parity is described in this example, any amount of redundancy in a RAID data layout architecture may be chosen.

During operation, the RAID engine 178 may monitor characteristics of the storage devices 176a-176k and determine the devices are exhibiting a reliability level higher than an initial or other given reliability level. In response, the RAID engine 178 may change the RAID protection from a RAID double parity to a RAID single parity. In other RAID data layout architectures, another reduction in the amount of supported redundancy may be used. In other embodiments, the monitoring of storage devices 176a-176k and changing a protection level may be performed by other logic within storage controller 174.

Continuing with the above example, only single parity information may be generated and stored for subsequent write operations executing on a given RAID stripe. For example, storage device 176k may not be used in subsequent RAID stripes for write operations after the change in the amount of supported redundancy. In addition, data stored in storage device 176k may be invalidated, thereby freeing the storage. Pages corresponding to freed data in storage device 176k may then be reallocated for other uses. The process of reducing an amount of parity protection and freeing space formerly used for storing parity protection data may be referred to as “parity shredding”. In addition, in an embodiment wherein storage device 176k is an SSD, one or more erase operations may occur within storage device 176k prior to rewriting the pages within stripe 250a.

Continuing with the above example of parity shredding, the data stored in the reallocated pages of storage device 176k within stripe 250a after parity shredding may hold user data or corresponding RAID single parity information for other RAID stripes that do not correspond to stripe 250a. For example, the data stored in storage devices 176a-176j within stripe 250a may correspond to one or more write operations executed prior to parity shredding. The data stored in storage device 176k within stripe 250a may correspond to one or more write operations executed after parity shredding. Similarly, the data stored in storage devices 176a-176j within stripe 250b may correspond to one or more write operations executed prior to parity shredding. The pages in storage device 176k within stripe 250b may be freed, later erased, and later rewritten with data corresponding to one or more write operations executed after the change in the amount of supported redundancy. It is noted that this scheme may be even more effective when redundancy information is rotated across storage devices. In such an embodiment, space that is freed by shredding will likewise be distributed across the storage devices.

Referring again to FIG. 8, the deallocated pages shown in storage device 176k within stripe 250c represent storage locations that may have previously stored RAID double parity information prior to parity shredding. However, now these pages are invalid and have not yet been reallocated. Particular characteristics of an SSD determine the manner and the timing of both freeing and reallocating pages within storage device 176k in the above example. Examples of these characteristics include at least erasing an entire erase block prior to reprogramming (rewriting) one or more pages. As can be seen from FIG. 8, when parity is shredded, it is not necessary to shred an entire device. Rather, parity may be shredded for individual stripes as desired. Similarly, parity protection for a stripe may be increased may adding protection data stored on an additional device to a stripe.

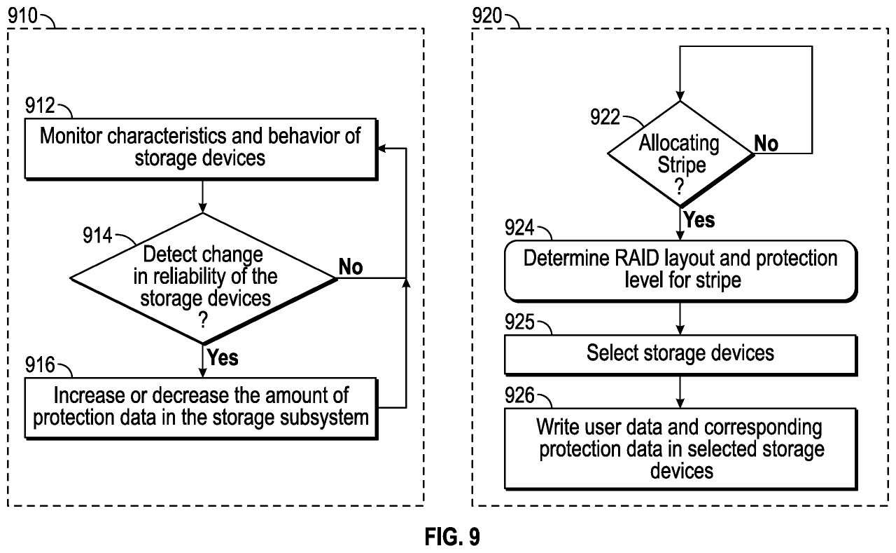

Referring now to FIG. 9, one embodiment of a method for dynamically determining a RAID layout is shown. The components embodied in network architecture 100 and data storage arrays 120a-120b described above may generally operate in accordance with method 900. In FIG. 9, two processes 910 and 920 are shown. Each of the processes may operate concurrently, or in a given order. Further, the steps in this embodiment are shown in sequential order. However, some steps may occur in a different order than shown, some steps may be performed concurrently, some steps may be combined with other steps, and some steps may be absent in another embodiment. Block 910 illustrates a process whereby a storage control system monitors the characteristics and behaviors of storage devices in the system (block 912). For example, characteristics such as those described in FIG. 6 may be observed and/or recorded. If a particular condition is detected, such as a change in reliability (decision block 914), then a change in the amount of protection used for stored data may be made (block 916). For example, when given devices are relatively young in age, the reliability of the devices may not be known (e.g., the devices may suffer “infant mortality” and fail at a relatively young age). Therefore, one or more extra storage devices per RAID stripe may be used to store parity information. At a later time, this extra protection may be removed when the devices prove over time that they are reliable. In various embodiments, characteristics regarding error rates may be maintained for devices. For example, characteristics concerning correctable and/or uncorrectable errors may be maintained and used to make decisions regarding the reliability of a given device. Based upon this information, the storage controller may dynamically alter various levels of protection for a device or stripe.

Block 920 of FIG. 9 generally illustrates a process whereby at the time a stripe or other portion of storage is to be allocated (decision block 922), a determination regarding the layout and protection level to use for the data may be made (block 924). It is noted that the process of block 910 could be performed at this time. Alternatively, levels of protection may have been determined by process 910 and stored. The determination of block 924 could then be based upon that stored data. In one embodiment, once a given layout has been determined, the particular devices to be used for the layout may be selected from a group of devices (block 925). For example, in one embodiment a group of 20 devices may be available for use. If a layout of 5+2 is determined, then any seven devices may be selected for use from the group of 20. Additionally, it is noted that a subsequent write with a selected 5+2 layout need not use the same 7 devices. Subsequent to determining the layout, protection level, and devices for the stripe, the stripe may be written (block 926).

In various embodiments, the RUSH algorithm may be utilized to determine which devices on which the data and redundancy information for a given stripe will reside. For example, the RUSH algorithm may be used to select the particular devices to utilize for an 8+2 RAID layout for a given stripe in storage devices 176a-176k. Generally speaking, as used herein, an M+N layout may generally describe a layout which includes M data devices and N parity devices for a given data stripe. Additionally, as discussed above, parity may be distributed across the devices rather than fully located within particular devices. Accordingly, an 8+2 layout may include data and parity striped across 10 devices—with 8 of the devices storing data and two of the devices storing parity. On a subsequent occasion, a layout of 12+2 may be selected. In this manner, the desired layout and protection characteristics may be determined dynamically at the time a write (e.g., a stripe) is to be written. In one embodiment, storage devices 176a-176k may include more than 10 storage devices, such as 30, 50 or more storage devices. However, for a stripe with an 8+2 layout, only 10 of the storage devices are utilized. It is noted that any 10 of the devices may be selected and any suitable algorithm may be used for selecting the 10 devices for use in storing the stripe. For example, the CRUSH algorithm could be used to select which 10 of the storage devices 176a-176k to utilize for a given 8+2 RAID layout.

In one example of a chosen 8+2 RAID layout for storage devices 176a-176k, 2 of the storage devices may be used to store error correcting code (ECC) information, such as parity information. This information may be used to perform reconstruct read requests. Referring again to FIG. 8, the storage devices 176j and 176k may be selected to store RAID double parity information in this example. Again, the parity information may be stored in a rotated fashion between each of the storage devices 176a-176k included within the RAID array, rather than consistently stored in the same storage devices. For ease of illustration and description, the storage devices 176j and 176k are described as storing RAID double parity.

In block 926, during execution of a write operation, metadata, user data, intra-device parity information and inter-device parity information may be written as a RAID stripe across multiple storage devices included within the RAID array. In block 912, the RAID engine 178 may monitor behavior of the one or more storage devices within the RAID array. In one embodiment, the RAID engine 178 may include a monitor 410 and data layout logic 420 as shown in FIG. 4. The RAID engine 178 may monitor at least an age of a given storage device, a number and a type of errors, detected configuration changes since a last allocation of data, an age of given data, a current usage of storage space in the RAID array, and so forth.

The data, which is monitored by the RAID engine 178, may be stored in RAM 172, such as in one of the device units 400a-400w shown in FIG. 4. Tables may be used to store this data, such as the examples shown in FIG. 5 and FIG. 6. The logic included within a corresponding RAID engine may both detect and predict behavior of storage devices by monitoring updated statistics of the storage devices. For example, the model may predict an upcoming increasing error rate for a given storage device.

If increased reliability of the storage device(s) is detected (conditional block 908), then in block 910, the RAID engine may decrease the level of data protection within the system. For example, in one embodiment the amount of parity information stored in the storage subsystem may be reduced. Regarding the above example, the RAID engine may decrease the RAID double parity to RAID single parity for the corresponding 8+2 RAID array, converting it to an 8+1 RAID array. In other examples a given RAID array may be utilizing an N-level amount of redundancy, or parity, in a RAID architecture prior to block 916. In block 916, the RAID engine may determine to utilize an (N-m)-level amount of redundancy, wherein N>1 and 1<m<N. Therefore, during subsequent write operations for a given RAID stripe, there will be m fewer storage devices written to within the given RAID stripe.

In order to reduce the level of data protection within the system, the RAID engine (or another component) may perform parity shredding as described earlier. Subsequently, the storage controller 174 may reallocate those pages which were freed as a result of the shredding operation to be used in subsequent write operations.

As each of the storage devices 176a-176k both age and fill up with data, extra parity information may be removed from the RAID array as described above. The metadata, the user data, corresponding intra-device redundancy information and some of the inter-device redundancy information remains. Regarding the above example with an 8+2 RAID array, the information stored in storage devices 176a-176j remains. However, extra inter-device redundancy information, or extra parity information, may be removed from the RAID array. For example, extra parity information stored in storage device 176k may be removed from the RAID stripes.

The information that remains, such as the information stored in storage devices 176a-176j in the above example, may remain in place. The storage space storing the extra parity information, such as the corresponding pages in storage device 176k in the above example, may be reused and reallocated for subsequent write operations. In one embodiment, each new allocation receives a new virtual address. Each new allocation may have any given size, any given alignment or geometry, and may fit in any given storage space (either virtual or physical). In one embodiment, each one of the storage devices 176a-176k and each allocated page within a storage device have a header comprising identification information. This identification information may allow the reuse of storage space for freed extra parity information without changing a given configuration.

In an embodiment wherein one or more of the storage devices 176a-176k is an SSD, an erase block is erased prior to reprogramming one or more pages within the erase block. Therefore, in an embodiment wherein storage device 176k is an SSD, corresponding erase blocks are erased prior to reprogramming freed pages in storage device 176k. Regarding the above example with an original 8+2 RAID array, one or more erase blocks are erased in storage device 176k within stripes 250a-250b prior to reprogramming pages with data 210. The original 8+2 RAID array is now an 8+1 RAID array with storage device 176j providing the single parity information for RAID stripes written prior to the parity shredding.

As is well known to those skilled in the art, during a read or write failure for a given storage device, data may be reconstructed from the supported inter-device parity information within a corresponding RAID stripe. The reconstructed data may be written to the storage device. However, if the reconstructed data fails to be written to the storage device, then all the data stored on the storage device may be rebuilt from corresponding parity information. The rebuilt data may be relocated to another location. With Flash memory, a Flash Translation Layer (FTL) remaps the storage locations of the data. In addition, with Flash memory, relocation of data includes erasing an entire erase block prior to reprogramming corresponding pages within the erase block. Maintaining mapping tables at a granularity of erase blocks versus pages allows the remapping tables to be more compact. Further, during relocation, extra pages that were freed during parity shredding may be used.

Offset Parity

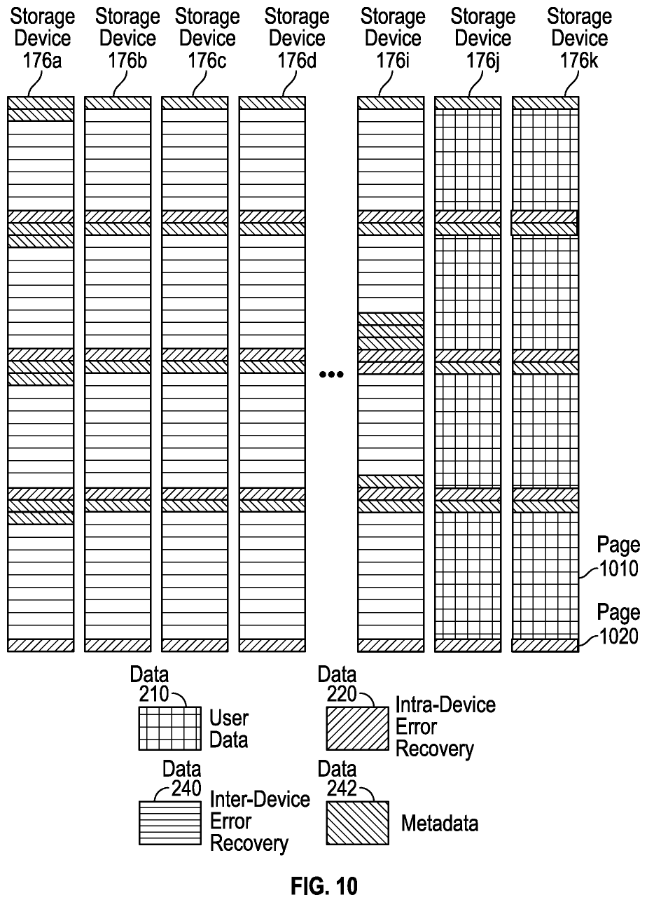

Turning now to FIG. 10, a generalized block diagram illustrating yet another embodiment of a flexible RAID data layout architecture is shown. Similar to the generalized block diagram shown in FIG. 8, a flexible RAID data layout architecture may be used. The storage devices 176a-176k comprise multiple RAID stripes laid out across multiple storage devices. Although each of the storage devices 176a-176k comprises multiple pages, only page 1010 and page 1020 are labeled for ease of illustration. In the example shown, a double parity RAID data layout is chosen, wherein storage devices 176j and 176k store double parity information.

Each of the pages in the storage devices 176a-176k stores a particular type of data. Some pages store user data 210 and corresponding generated inter-device parity information 240. Other pages store corresponding generated intra-device parity information 220. Yet other pages store metadata 242. The metadata 242 may include page header information, RAID stripe identification information, log data for one or more RAID stripes, and so forth. In addition to inter-device parity protection and intra-device parity protection, each of the pages in storage devices 176a-176k may comprise additional protection such as a checksum stored within each given page. In various embodiments, the single metadata page at the beginning of each stripe may be rebuilt from the other stripe headers. Alternatively, this page could be at a different offset in the parity shard so the data can be protected by the inter-device parity. A “shard” represents a portion of a device. Accordingly, a parity shard refers to a portion of a device storing parity data.

Physical Layer

In various embodiments, the systems described herein may include a physical layer through which other elements of the system communicate with the storage devices. For example, scheduling logic, RAID logic, and other logic may communicate with the storage devices via a physical layer comprising any suitable combination of software and/or hardware. In general, the physical layer performs a variety of functions including providing access to persistent storage, and performing functions related to integrity of data storage.

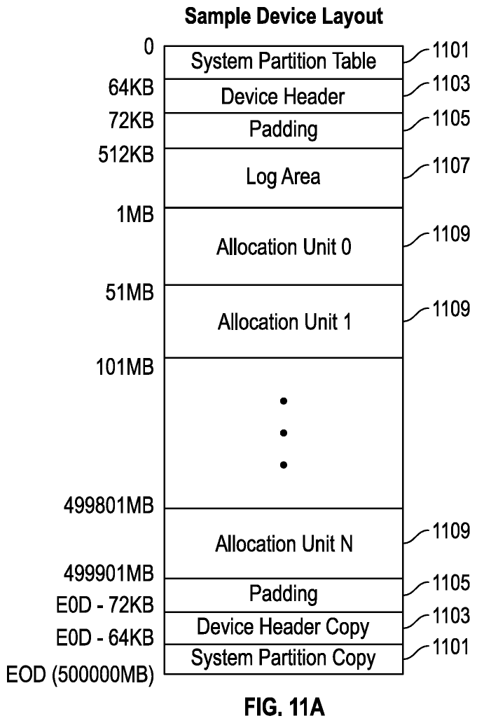

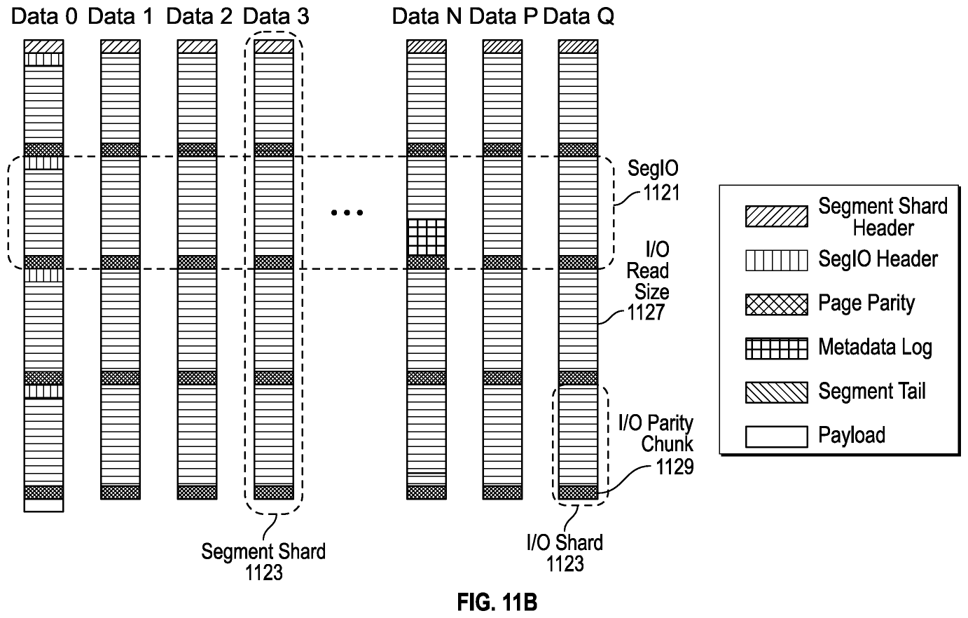

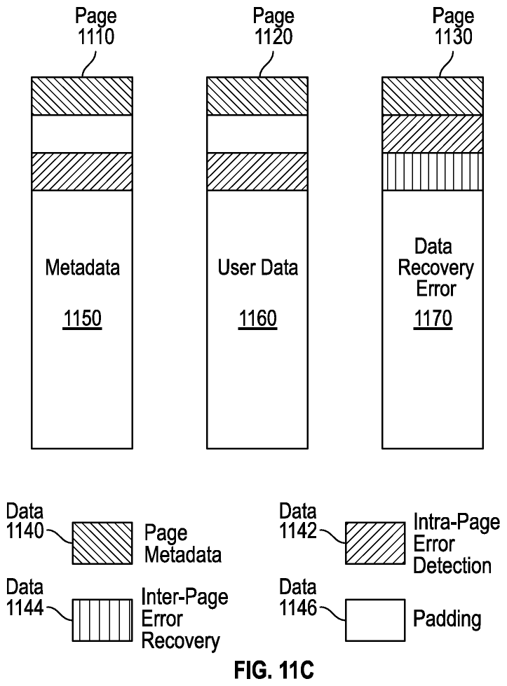

FIG. 11A illustrates one embodiment of a hypothetical device layout for a 500 GB device. In various embodiments, the storage devices described herein may be formatted with a partition table 1101 at the beginning of the device, and a copy of the partition table at the end of the device. Additionally, a device header 1103 may be stored in the first and last blocks. For example, in a flash based storage device, a device header may be stored in the first and last erase blocks. As previously discussed, an erase block is a flash construct that is typically in the range of 256 KB-1 MB. Additional unused space in the first erase block may be reserved (padding 1105). The second erase block in each device may be reserved for writing logging and diagnostic information 1107. The rest of the erase blocks in between are divided into Allocation Units (AUs) 1109 of a multiple erase blocks. The AU size may be chosen so there are a reasonable number of AUs per device for good allocation granularity. In one embodiment, there may be something in the range of 10,000 AUs on a device to permit allocation in large enough units to avoid overhead, but not too many units for easy tracking. Tracking of the state of an AU (allocated/free/erased/bad) may be maintained an AU State Table. The wear level of an AU may be maintained in a Wear Level Table, and a count of errors may be maintained in an AU Error Table.

In various embodiments, the physical layer allocates space in segments which include one segment shard in each device across a set of devices (which could be on different nodes). FIG. 11B depicts one embodiment of a segment and various identifiable portions of that segment in one possible segment layout. In the embodiment shown, a single segment is shown stored in multiple devices. Illustrated are data devices Data 0-Data N, and parity devices Parity P and Parity Q. In one embodiment, each segment shard includes one or more allocation units on a device such that the size of the shard is equal on each device. Segment shard 1123 is called out to illustrate a segment shard. Also illustrated if FIG. 11B, is an I/O read size 1127 which in one embodiment corresponds to a page. Also shown is an I/O parity chunk 1129 which may include one or more pages of page parity for the I/O shard.

In one embodiment, each segment will have its own geometry which may include one or more of the following parameters:
(1) RAID level—The RAID level used for cross device protection in the segment. This may determine mirroring, parity, or ECC RAID and how many segment shards contain parity.
(2) Device Layout I/O shard size—This represents the size used to stripe across each device during a write. This will typically be in the range of 256 KB to 1 MB and probably be a multiple of the erase block size on each device. FIG. 11B calls out I/O shard size 1125 for purposes of illustration.
(3) I/O read size—This is a logical read size. Each I/O shard may be formatted as a series of logical pages. Each page may in turn include a header and a checksum for the data in the page. When a read is issued it will be for one or more logical pages and the data in each page may be validated with the checksum.
(4) I/O shard RAID level—The I/O shard has intra-shard parity to handle latent errors found during a rebuild. This parameter determines what type of parity is used for intra-shard protection and thus how many copies of the intra-shard parity will be maintained.
(5) I/O parity chunk—In various embodiments, the storage devices may do ECC on a page basis. Consequently, if an error is seen it is likely to indicate failure of an entire physical page. The I/O parity chunk is the least common multiple of the physical page size on each device in the segment and the intra-shard parity is calculated by striping down the I/O shard in the larger of the I/O parity chunks or the I/O read size. Included may be one or more pages of page parity. In various embodiments, this parity may be used to rebuild data in the event of a failed checksum validation.

In various embodiments, as each new segment is written a RAID geometry for the segment will be selected. Selection of the RAID geometry may be based on factors such as the current set of active nodes and devices, and the type of data in the segment. For example, if 10 nodes or devices are available then an (8+2) RAID 6 geometry may be chosen and the segment striped across the nodes to withstand two device or node failures. If a node then fails, the next segment may switch to a (7+2) RAID 6 geometry. Within the segment some of the segment shards will contain data and some will contain ECC (e.g., parity).

In one embodiment, there are five types of segments. Three of these segments correspond to the AU State Table, the AU Error Table, and the Wear Level Table. In some embodiments, these three segments may be mirrored for additional protection. In addition to these three segments, there are metadata segments which may also be additionally protected through mirroring. Finally, there are Data segments which hold client blocks and log information. The log information contains update information associated with the client blocks in the segment. The data segments will likely be protected by RAID 6 as illustrated in FIG. 11B with Parity P and Parity Q shards. In addition to the above, a segment table is maintained as an in memory data structure that is populated at startup with information from the headers of all the segment shards. In some embodiments, the table may be cached completely on all nodes so any node can translate a storage access to a physical address. However, in other embodiments an object storage model may be used where each node may have a segment table that can take a logical reference and identify the segment layout node where the data is stored. Then the request would be passed to the node to identify the exact storage location on the node. FIG. 11B also depicts segment tail data which identifies any (volume, snapshot) combinations that take up a significant amount of space in the segment. When snapshots are removed, a data scrubber may help identify segments for garbage collection based on this data.

In one embodiment, the basic unit of writing is the segio which is one I/O shard on each of the devices in the segment. Each logical page in the segio is formatted with a page header that contains a checksum (which may be referred to as a “media” checksum) of the page so the actual page size for data is slightly smaller than one page. For pages in the parity shards of a segment the page header is smaller so that the page checksums in the data page are protected by the parity page. The last page of each I/O shard is a parity page that again has a smaller header and protects all the checksums and page data in the erase block against a page failure. The page size referred to here is the I/O read size which may be one or more physical flash pages. For some segments, a read size smaller than a physical page may be used. This may occur for metadata where reads to lookup information may be index driven and smaller portion of data may be read while still obtaining the desired data. In such a case, reading half a physical page would mean tying up the I/O bus (and network) with less data and validating (e.g., checksumming) less data. To support a read size smaller than a physical page, an embodiment may include multiple parity pages at the end of the erase block such that the total size of all the parity pages is equal to the flash page size.

As the wear level of an erase block increases, the likelihood of an error increases. In addition to tracking wear levels, data may be maintained regarding observed how often errors are seen on an erase block and blocks with a higher probability of error identified. For some erase blocks, it may be decided to keep double or triple error correcting parity at the end of the erase block instead of the single RAID 5 parity. In this case, the data payload of the segio may be reduced accordingly. It may only be necessary to reduce the poor erase block within the segio, rather than all the erase blocks. The page headers in the erase block may be used to identify which pages are parity and which are data.

Whenever a page is read from storage, the contents may be validated using the page checksum. If the validation fails, a rebuild of the data using the erase block parity may be attempted. If that fails, then cross device ECC for the segment may be used to reconstruct the data.

In data segments the payload area may be divided into two areas. There will be pages formatted as log data which may include updates related to stored client blocks. The remainder of the payload area may contain pages formatted as client blocks. The client block data may be stored in a compressed form. Numerous compression algorithms are possible and are contemplated. Additionally, in various embodiments Intel® Advanced Encryption Standard instructions may be used for generating checksums. Additionally, there may be a header for the client block that resides in the same page as the data and contains information needed to read the client block, including an identification of the algorithm used to compress the data. Garbage collection may utilize both the client block header and the log entries in the segio. In addition, the client block may have a data hash which may be a checksum of the uncompressed data used for deduplication and to check the correctness of the decompressed data.

In some embodiments, segments and segios may have a monotonically increasing ID number used to order them. As part of writing a segio, a logical layer can record dependencies on prior flushes. At startup, the physical layer may build an ordered list of segments and segios and if a segio is dependent on another uncompleted segio it may be rolled back and not considered to have been written.

### Wear Level Table

The Wear Level Table (WLT) for each device may be stored in a segment local to each device. The information may also be stored in the header of each segment shard. In one embodiment, the wear information is an integer that represents the number of times the allocation unit has been erased and reused. As the wear information may not be accurate, a flush of the table to the device may be performed when there has been a certain amount of activity or when the system has been idle for a reasonable period. The WLT may also be responsible for cleaning up old WLT segments as it allocates new ones. To add an extra layer of protection, old copies may be maintained before freeing them. For example, a table manager may ensure that it keeps the previous erase block and the current erase block of WLT entries at all times. when it allocates a new segment it won't free the old segment until it has written into the second erase block of the new segment.

### AU State Table

The AU State Table (AST) tracks the state of each AU. The states include Free, Allocated, Erased and Bad. The AST may be stored in a segment on the device. Changing a state to Allocated or Free may be a synchronous update, while changing a state to Bad or Erased may be an asynchronous update. This table may generally be small enough and have enough updates that updates may be logged in NVRAM. The AST may be responsible for cleaning up old AST segments as it allocates new ones. Since the AST can be completely recovered by scanning the first block of each AU on the drive, there is no need to keep old copies of the AST.

### AU Error Table

The AU Error Table (AET) may be used to track the number of recoverable errors and unrecoverable errors within each AU. The AET is stored in a segment on the device and each field may be a two-byte integer. With four bytes per AU the entire table may be relatively small.

Referring now to FIG. 11C, a generalized block diagram illustrating one embodiment of data storage arrangements within different page types is shown. In the embodiment shown, three page types are shown although other types are possible and contemplated. The shown page types include page 1110 comprising metadata 1150, page 1120 comprising user data 1160, and page 1130 comprising parity information 1170 (inter-device or intra-device). Each of the pages 1110-1130 comprises metadata 1140, which may include header and identification information. In addition, each of the pages 1110-1130 may comprise intra-page error recovery data 1142, such as a corresponding checksum or other error detecting and/or correcting code. This checksum value may provide added protection for data stored in storage devices 176a-176k in a given device group.

Further, page 1130 may comprise inter-page error recovery data 1144. The data 1144 may be ECC information derived from the intra-page data 1142 stored in other storage devices. For example, referring again to FIG. 10, each page within storage device 176j, which stores inter-device parity information 240, may also store inter-page error recovery data 1144. The data 1144 may be a parity, a checksum, or other value generated from intra-page error recovery data 1142 stored in one or more of the storage devices 176a-176i. In one embodiment, the data 1144 is a checksum value generated from one or more other checksum values 1142 stored in other storage devices. In order to align data 1144 in a given page in storage device 176j with data 1142 in a corresponding page in one or more of the storage devices 176a-176i, padding 1146 may be added to the corresponding pages.

In one embodiment, end-user applications perform I/O operations on a sector-boundary, wherein a sector is 512 bytes for HDDs. In order to add extra protection, an 8-byte checksum may be added to form a 520-byte sector. In various embodiments, compression and remapping may be used in a flash memory based system to allow user data to be arranged on a byte boundary rather than a sector boundary. In addition, a checksum (8 byte, 4 byte, or otherwise) may be placed inside a page after a header and before the user data, which may be compressed. This placement is shown in each of pages 1110-1130.

When an end-user application reads a 512-byte sector, a corresponding page, which may be 2 KB-8 KB in size in one embodiment, has extra protection with an 8-byte checksum at the beginning of the page. In various embodiments, the page may not be formatted for a non-power of 2 sector size. As shown in pages 1110-1120, the checksum may be offset a few bytes into the page. This offset allows a parity page, such as page 1130, to store both a checksum that covers the parity page and ECC to protect checksums of the other pages.

For yet another level of protection, data location information may be included when calculating a checksum value. The data 1142 in each of pages 1110-1130 may include this information. This information may include both a logical address and a physical address. Sector numbers, data chunk and offset numbers, track numbers, plane numbers, and so forth may be included in this information as well.

Alternate Geometries

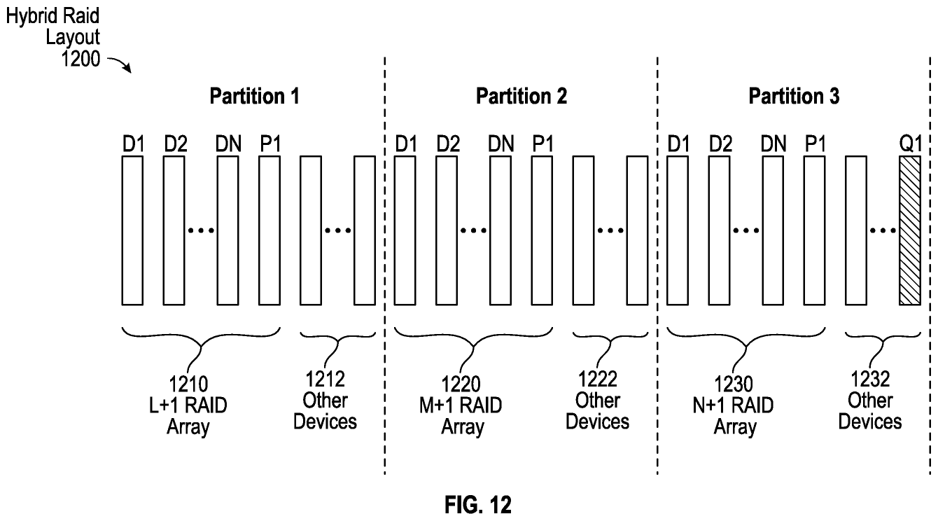

Turning now to FIG. 12, a generalized block diagram illustrating one embodiment of a hybrid RAID data layout 1200 is shown. Three partitions are shown although any number of partitions may be chosen. Each partition may correspond to a separate device group, such as device groups 713a-173b shown in FIG. 1. Each partition comprises multiple storage devices. In one embodiment, an algorithm such as the CRUSH algorithm may be utilized to select which devices to use in a RAID data layout architecture to use for data storage.

In the example shown, an L+1 RAID array, M+1 RAID array, and N+1 RAID array are shown. In various embodiments, L, M, and N may all be different, the same, or a combination thereof. For example, RAID array 1210 is shown in partition 1. The other storage devices 1212 are candidates for other RAID arrays within partition 1. Similarly, RAID array 1220 illustrates a given RAID array in partition 2. The other storage devices 1222 are candidates for other RAID arrays within partition 2. RAID array 1230 illustrates a given RAID array in partition 3. The other storage devices 1232 are candidates for other RAID arrays within partition 3.

Within each of the RAID arrays 1210, 1220 and 1230, a storage device P1 provides RAID single parity protection within a respective RAID array. Storage devices D1-DN store user data within a respective RAID array. Again, the storage of both the user data and the RAID single parity information may rotate between the storage devices D1-DN and P1. However, the storage of user data is described as being stored in devices D1-DN. Similarly, the storage of RAID single parity information is described as being stored in device P1 for ease of illustration and description.

One or more logical storage devices among each of the three partitions may be chosen to provide an additional amount of supported redundancy for one or more given RAID arrays. In various embodiments, a logical storage device may correspond to a single physical storage device. Alternatively, a logical storage device may correspond to multiple physical storage devices. For example, logical storage device Q1 in partition 3 may be combined with each of the RAID arrays 1210, 1220 and 1230. The logical storage device Q1 may provide RAID double parity information for each of the RAID arrays 1210, 1220 and 1230. This additional parity information is generated and stored when a stripe is written to one of the arrays 1210, 1220, or 1230. Further this additional parity information may cover stripes in each of the arrays 1210, 1220, and 1230. Therefore, the ratio of a number of storage devices storing RAID parity information to a total number of storage devices is lower. For example, if each of the partitions used N+2 RAID arrays, then the ratio of a number of storage devices storing RAID parity information to a total number of storage devices is 3(2)/(3(N+2)), or 2/(N+2). In contrast, the ratio for the hybrid RAID layout 1200 is (3+1)/(3(N+1)), or 4/(3(N+1)).

It is possible to reduce the above ratio by increasing a number of storage devices used to store user data. For example, rather than utilize storage device Q1, each of the partitions may utilize a 3N+2 RAID array. In such a case, the ratio of a number of storage devices storing RAID parity information to a total number of storage devices is 2/(3N+2). However, during a reconstruct read operation, (3N+1) storage devices receive a reconstruct read request for a single device failure. In contrast, for the hybrid RAID layout 1200, only N storage devices receive a reconstruct read request for a single device failure.

It is noted each of the three partitions may utilize a different RAID data layout architecture. A selection of a given RAID data layout architecture may be based on a given ratio number of storage devices storing RAID parity information to a total number of storage devices. In addition, the selection may be based on a given number of storage devices, which may receive a reconstruct read request during reconstruction. For example, the RAID arrays 1210, 1220 and 1230 may include geometries such as L+a, M+b and N+c, respectively.

In addition, one or more storage devices, such as storage device Q1, may be chosen based on the above or other conditions to provide an additional amount of supported redundancy for one or more of the RAID arrays within the partitions. In an example with three partitions comprising the above RAID arrays and a number Q of storage devices providing extra protection for each of the RAID arrays, a ratio of a number of storage devices storing RAID parity information to a total number of storage devices is (a+b+c+Q)/(L+a+M+b+N+c+Q). For a single device failure, a number of storage devices to receive a reconstruct read request is L, M and N, respectively, for partitions 1 to 3 in the above example. It is noted that the above discussion generally describes 3 distinct partitions in FIG. 12. In such an embodiment, this type of “hard” partitioning where a given layout is limited to a particular group of devices may guarantee that reconstruct reads in one partition will not collide with those in another partition. However, in other embodiments the partitions may not be hard as described above. Rather, given a pool of devices, layouts may be selected from any of the devices. For example, treating the devices as on big pool it is possible to configure layouts such as (L+1, M+1, N+1)+1. Consequently, there is a chance that geometries overlap and reconstruct reads could collide. If L, M, and N are small relative to the size of the pool then the percentage of reconstruct reads relative to normal reads may be kept low. As noted above, the additional redundancy provided by Q1 may not correspond to a single physical device. Rather, the data corresponding to the logical device Q1 may in fact be distributed among two or more of the devices depicted in FIG. 12. In addition, in various embodiments, the user data (D), parity data (P), and additional data (Q) may all be distributed across a plurality of devices. In such a case, each device may store a mix of user data (D), parity data (P), and additional parity data (Q).

In addition to the above, in various embodiments, when writing a stripe, the controller may select from any of the plurality of storage devices for one or more of the first RAID layout, the second RAID layout, and storage of redundant data by the additional logical device. In this manner, all of these devices may participate in the RAID groups and for different stripes the additional logical device may be different. In various embodiments, a stripe is a RAID layout on the first subset plus a RAID layout on the second subset plus the additional logical device.

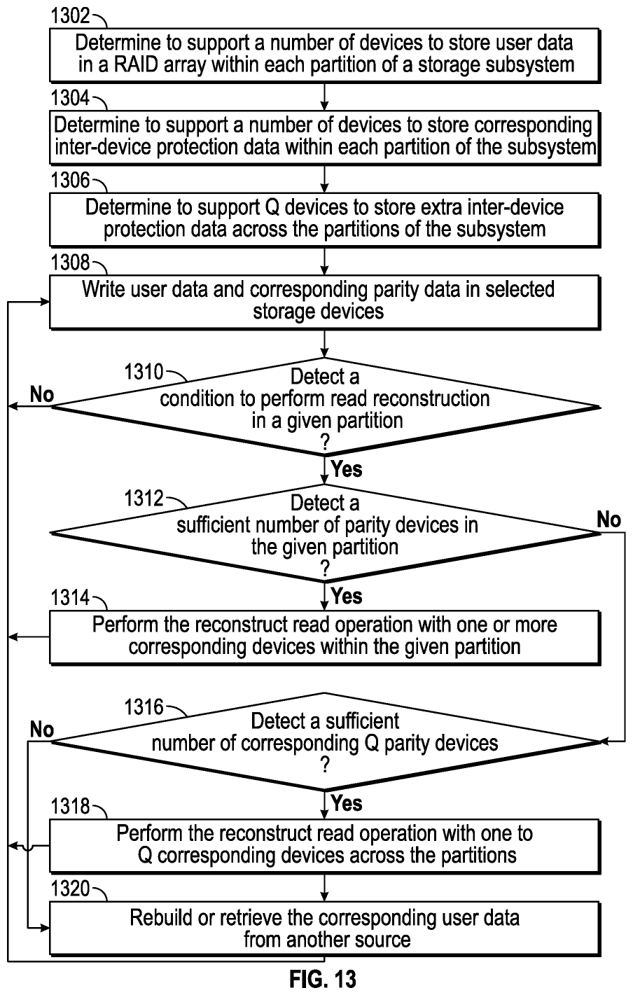

Referring now to FIG. 13, one embodiment of a method 1300 for selecting alternate RAID geometries in a data storage subsystem is shown. The components embodied in network architecture 100 and data storage arrays 120a-120b described above may generally operate in accordance with method 1300. The steps in this embodiment are shown in sequential order. However, some steps may occur in a different order than shown, some steps may be performed concurrently, some steps may be combined with other steps, and some steps may be absent in another embodiment.

In block 1302, a RAID engine 178 or other logic within a storage controller 174 determines to use a given number of devices to store user data in a RAID array within each partition of a storage subsystem. A RUSH or other algorithm may then be used to select which devices are to be used. In one embodiment, each partition utilizes a same number of storage devices. In other embodiments, each partition may utilize a different, unique number of storage devices to store user data. In block 1304, the storage controller 174 may determine to support a number of storage devices to store corresponding Inter-Device Error Recovery (parity) data within each partition of the subsystem. Again, each partition may utilize a same number or a different, unique number of storage devices for storing RAID parity information.

In block 1306, the storage controller may determine to support a number Q of storage devices to store extra Inter-Device Error Recovery (parity) data across the partitions of the subsystem. In block 1308, both user data and corresponding RAID parity data may be written in selected storage devices. Referring again to FIG. 12, when a given RAID array is written, such as RAID array 1210 in partition 1, one or more bits of parity information may be generated and stored in storage device Q1 in partition 3.

If the storage controller 174 detects a condition for performing read reconstruction in a given partition (conditional block 1310), and if the given partition has a sufficient number of storage devices holding RAID parity information to handle a number of unavailable storage devices (conditional block 1312), then in block 1314, the reconstruct read operation(s) is performed with one or more corresponding storage devices within the given partition. The condition may include a storage device within a given RAID array is unavailable due to a device failure or the device operates below a given performance level. The given RAID array is able to handle a maximum number of unavailable storage devices with the number of storage devices storing RAID parity information within the given partition. For example, if RAID array 1210 in partition 1 in the above example is an L+a RAID array, then RAID array 1210 is able to perform read reconstruction utilizing only storage devices within partition 1 when k storage devices are unavailable, where 1<=k<=a.

If the given partition does not have a sufficient number of storage devices holding RAID parity information to handle a number of unavailable storage devices (conditional block 1312), and if there is a sufficient number of Q storage devices to handle the number of unavailable storage devices (conditional block 1316), then in block 1318, the reconstruct read operation(s) is performed with one or more corresponding Q storage devices. One or more storage devices in other partitions, which are storing user data, may be accessed during the read reconstruction. A selection of these storage devices may be based on a manner of a derivation of the parity information stored in the one or more Q storage devices. For example, referring again to FIG. 12, storage device D2 in partition 2 may be accessed during the read reconstruction, since this storage device may have been used to generate corresponding RAID parity information stored in storage device Q1. If there are not a sufficient number of Q storage devices to handle the number of unavailable storage devices (conditional block 1316), then in block 1320, the corresponding user data may be read from another source or be considered lost.

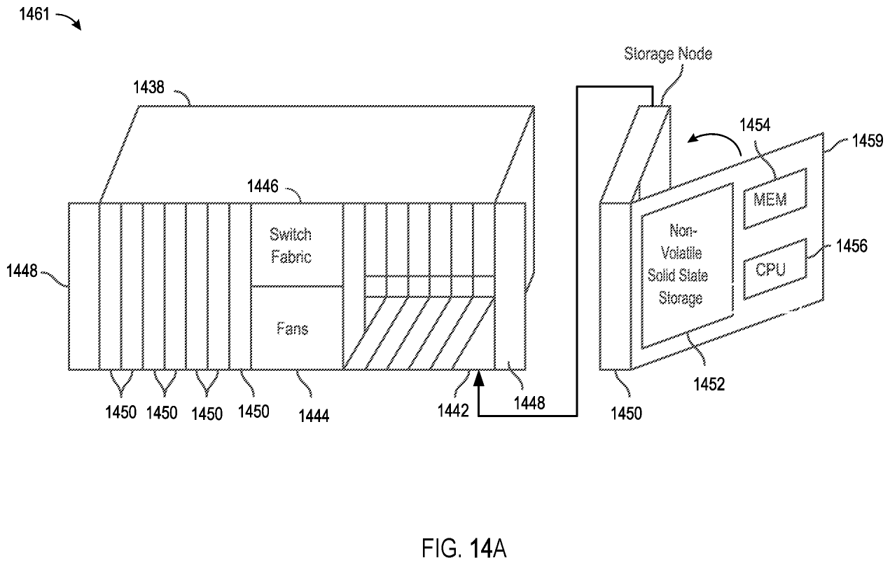

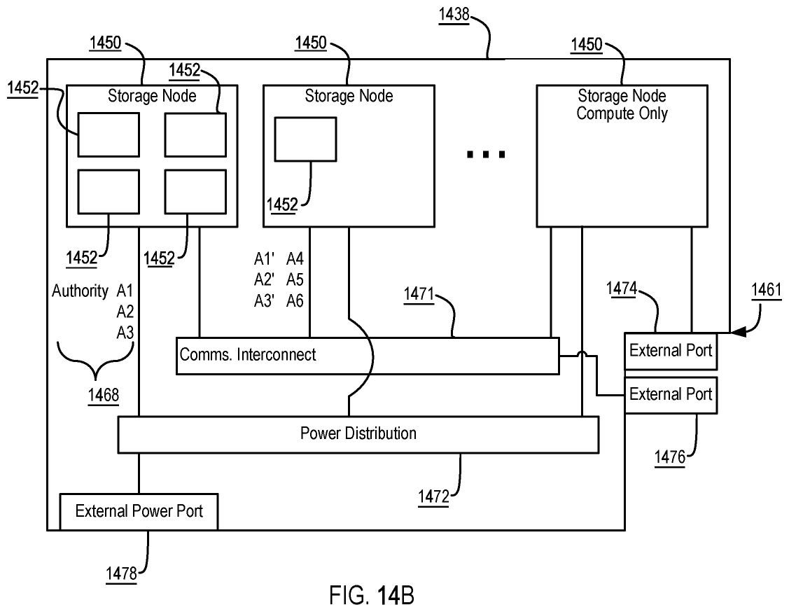

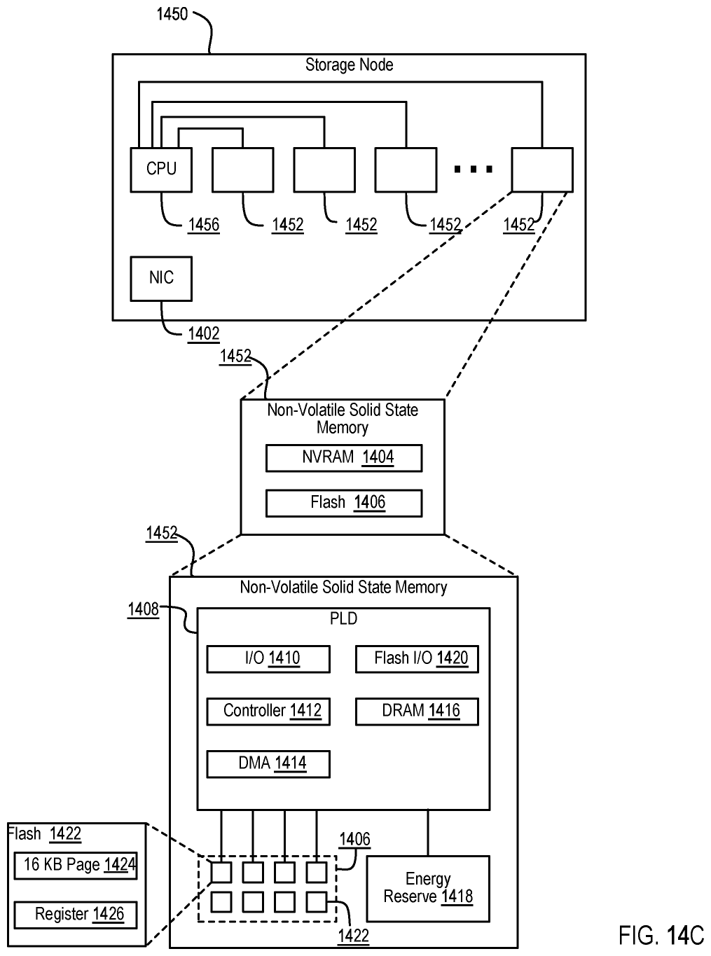

FIG. 14A is a perspective view of a storage cluster 1461, with multiple storage nodes 1450 and internal solid-state memory coupled to each storage node to provide network attached storage or storage area network, in accordance with some embodiments. A network attached storage, storage area network, or a storage cluster, or other storage memory, could include one or more storage clusters 1461, each having one or more storage nodes 1450, in a flexible and reconfigurable arrangement of both the physical components and the amount of storage memory provided thereby. The storage cluster 1461 is designed to fit in a rack, and one or more racks can be set up and populated as desired for the storage memory. The storage cluster 1461 has a chassis 1438 having multiple slots 1442. It should be appreciated that chassis 1438 may be referred to as a housing, enclosure, or rack unit. In one embodiment, the chassis 1438 has fourteen slots 1442, although other numbers of slots are readily devised. For example, some embodiments have four slots, eight slots, sixteen slots, thirty-two slots, or other suitable number of slots. Each slot 1442 can accommodate one storage node 1450 in some embodiments. Chassis 1438 includes flaps 1448 that can be utilized to mount the chassis 1438 on a rack. Fans 1444 provide air circulation for cooling of the storage nodes 1450 and components thereof, although other cooling components could be used, or an embodiment could be devised without cooling components. A switch fabric 1446 couples storage nodes 1450 within chassis 1438 together and to a network for communication to the memory. In an embodiment depicted in herein, the slots 1442 to the left of the switch fabric 1446 and fans 1444 are shown occupied by storage nodes 1450, while the slots 1442 to the right of the switch fabric 1446 and fans 1444 are empty and available for insertion of storage node 1450 for illustrative purposes. This configuration is one example, and one or more storage nodes 1450 could occupy the slots 1442 in various further arrangements. The storage node arrangements need not be sequential or adjacent in some embodiments. Storage nodes 1450 are hot pluggable, meaning that a storage node 1450 can be inserted into a slot 1442 in the chassis 1438, or removed from a slot 1442, without stopping or powering down the system. Upon insertion or removal of storage node 1450 from slot 1442, the system automatically reconfigures in order to recognize and adapt to the change. Reconfiguration, in some embodiments, includes restoring redundancy and/or rebalancing data or load.

Each storage node 1450 can have multiple components. In the embodiment shown here, the storage node 1450 includes a printed circuit board 1459 populated by a CPU 1456, i.e., processor, a memory 1454 coupled to the CPU 1456, and a non-volatile solid state storage 1452 coupled to the CPU 1456, although other mountings and/or components could be used in further embodiments. The memory 1454 has instructions which are executed by the CPU 1456 and/or data operated on by the CPU 1456. As further explained below, the non-volatile solid state storage 1452 includes flash or, in further embodiments, other types of solid-state memory.

Referring to FIG. 14A, storage cluster 1461 is scalable, meaning that storage capacity with non-uniform storage sizes is readily added, as described above. One or more storage nodes 1450 can be plugged into or removed from each chassis and the storage cluster self-configures in some embodiments. Plug-in storage nodes 1450, whether installed in a chassis as delivered or later added, can have different sizes. For example, in one embodiment a storage node 1450 can have any multiple of 4 TB, e.g., 8 TB, 12 TB, 16 TB, 32 TB, etc. In further embodiments, a storage node 1450 could have any multiple of other storage amounts or capacities. Storage capacity of each storage node 1450 is broadcast, and influences decisions of how to stripe the data. For maximum storage efficiency, an embodiment can self-configure as wide as possible in the stripe, subject to a predetermined requirement of continued operation with loss of up to one, or up to two, non-volatile solid state storage 1452 units or storage nodes 1450 within the chassis.

FIG. 14B is a block diagram showing a communications interconnect 1471 and power distribution bus 1472 coupling multiple storage nodes 1450. Referring back to FIG. 14A, the communications interconnect 1471 can be included in or implemented with the switch fabric 1446 in some embodiments. Where multiple storage clusters 1461 occupy a rack, the communications interconnect 1471 can be included in or implemented with a top of rack switch, in some embodiments. As illustrated in FIG. 14B, storage cluster 1461 is enclosed within a single chassis 1438. External port 1476 is coupled to storage nodes 1450 through communications interconnect 1471, while external port 1474 is coupled directly to a storage node. External power port 1478 is coupled to power distribution bus 1472. Storage nodes 1450 may include varying amounts and differing capacities of non-volatile solid state storage 1452 as described with reference to FIG. 14A. In addition, one or more storage nodes 1450 may be a compute only storage node as illustrated in FIG. 14B. Authorities 1468 are implemented on the non-volatile solid state storage 1452, for example as lists or other data structures stored in memory. In some embodiments the authorities are stored within the non-volatile solid state storage 1452 and supported by software executing on a controller or other processor of the non-volatile solid state storage 1452. In a further embodiment, authorities 1468 are implemented on the storage nodes 1450, for example as lists or other data structures stored in the memory 1454 and supported by software executing on the CPU 1456 of the storage node 1450. Authorities 1468 control how and where data is stored in the non-volatile solid state storage 1452 in some embodiments. This control assists in determining which type of erasure coding scheme is applied to the data, and which storage nodes 1450 have which portions of the data. Each authority 1468 may be assigned to a non-volatile solid state storage 1452. Each authority may control a range of inode numbers, segment numbers, or other data identifiers which are assigned to data by a file system, by the storage nodes 1450, or by the non-volatile solid state storage 1452, in various embodiments.

Every piece of data, and every piece of metadata, has redundancy in the system in some embodiments. In addition, every piece of data and every piece of metadata has an owner, which may be referred to as an authority. If that authority is unreachable, for example through failure of a storage node, there is a plan of succession for how to find that data or that metadata. In various embodiments, there are redundant copies of authorities 1468. Authorities 1468 have a relationship to storage nodes 1450 and non-volatile solid state storage 1452 in some embodiments. Each authority 1468, covering a range of data segment numbers or other identifiers of the data, may be assigned to a specific non-volatile solid state storage 1452. In some embodiments the authorities 1468 for all of such ranges are distributed over the non-volatile solid state storage 1452 of a storage cluster. Each storage node 1450 has a network port that provides access to the non-volatile solid state storage(s) 1452 of that storage node 1450. Data can be stored in a segment, which is associated with a segment number and that segment number is an indirection for a configuration of a RAID (redundant array of independent disks) stripe in some embodiments. The assignment and use of the authorities 1468 thus establishes an indirection to data. Indirection may be referred to as the ability to reference data indirectly, in this case via an authority 1468, in accordance with some embodiments. A segment identifies a set of non-volatile solid state storage 1452 and a local identifier into the set of non-volatile solid state storage 1452 that may contain data. In some embodiments, the local identifier is an offset into the device and may be reused sequentially by multiple segments. In other embodiments the local identifier is unique for a specific segment and never reused. The offsets in the non-volatile solid state storage 1452 are applied to locating data for writing to or reading from the non-volatile solid state storage 1452 (in the form of a RAID stripe). Data is striped across multiple units of non-volatile solid state storage 1452, which may include or be different from the non-volatile solid state storage 1452 having the authority 1468 for a particular data segment.

If there is a change in where a particular segment of data is located, e.g., during a data move or a data reconstruction, the authority 1468 for that data segment should be consulted, at that non-volatile solid state storage 1452 or storage node 1450 having that authority 1468. In order to locate a particular piece of data, embodiments calculate a hash value for a data segment or apply an inode number or a data segment number. The output of this operation points to a non-volatile solid state storage 1452 having the authority 1468 for that particular piece of data. In some embodiments there are two stages to this operation. The first stage maps an entity identifier (ID), e.g., a segment number, inode number, or directory number to an authority identifier. This mapping may include a calculation such as a hash or a bit mask. The second stage is mapping the authority identifier to a particular non-volatile solid state storage 1452, which may be done through an explicit mapping. The operation is repeatable, so that when the calculation is performed, the result of the calculation repeatably and reliably points to a particular non-volatile solid state storage 1452 having that authority 1468. The operation may include the set of reachable storage nodes as input. If the set of reachable non-volatile solid state storage units changes the optimal set changes. In some embodiments, the persisted value is the current assignment (which is always true) and the calculated value is the target assignment the cluster will attempt to reconfigure towards. This calculation may be used to determine the optimal non-volatile solid state storage 1452 for an authority in the presence of a set of non-volatile solid state storage 1452 that are reachable and constitute the same cluster. The calculation also determines an ordered set of peer non-volatile solid state storage 1452 that will also record the authority to non-volatile solid state storage mapping so that the authority may be determined even if the assigned non-volatile solid state storage is unreachable. A duplicate or substitute authority 1468 may be consulted if a specific authority 1468 is unavailable in some embodiments.

With reference to FIGS. 14A and 14B, two of the many tasks of the CPU 1456 on a storage node 1450 are to break up write data, and reassemble read data. When the system has determined that data is to be written, the authority 1468 for that data is located as above. When the segment ID for data is already determined the request to write is forwarded to the non-volatile solid state storage 1452 currently determined to be the host of the authority 1468 determined from the segment. The host CPU 1456 of the storage node 1450, on which the non-volatile solid state storage 1452 and corresponding authority 1468 reside, then breaks up or shards the data and transmits the data out to various non-volatile solid state storage 1452. The transmitted data is written as a data stripe in accordance with an erasure coding scheme. In some embodiments, data is requested to be pulled, and in other embodiments, data is pushed. In reverse, when data is read, the authority 1468 for the segment ID containing the data is located as described above. The host CPU 1456 of the storage node 1450 on which the non-volatile solid state storage 1452 and corresponding authority 1468 reside requests the data from the non-volatile solid state storage and corresponding storage nodes pointed to by the authority. In some embodiments the data is read from flash storage as a data stripe. The host CPU 1456 of storage node 1450 then reassembles the read data, correcting any errors (if present) according to the appropriate erasure coding scheme, and forwards the reassembled data to the network. In further embodiments, some or all of these tasks can be handled in the non-volatile solid state storage 1452. In some embodiments, the segment host requests the data be sent to storage node 1450 by requesting pages from storage and then sending the data to the storage node making the original request.

In embodiments, authorities 1468 operate to determine how operations will proceed against particular logical elements. Each of the logical elements may be operated on through a particular authority across a plurality of storage controllers of a storage system. The authorities 1468 may communicate with the plurality of storage controllers so that the plurality of storage controllers collectively perform operations against those particular logical elements.

In embodiments, logical elements could be, for example, files, directories, object buckets, individual objects, delineated parts of files or objects, other forms of key-value pair databases, or tables. In embodiments, performing an operation can involve, for example, ensuring consistency, structural integrity, and/or recoverability with other operations against the same logical element, reading metadata and data associated with that logical element, determining what data should be written durably into the storage system to persist any changes for the operation, or where metadata and data can be determined to be stored across modular storage devices attached to a plurality of the storage controllers in the storage system.

In some embodiments the operations are token based transactions to efficiently communicate within a distributed system. Each transaction may be accompanied by or associated with a token, which gives permission to execute the transaction. The authorities 1468 are able to maintain a pre-transaction state of the system until completion of the operation in some embodiments. The token based communication may be accomplished without a global lock across the system, and also enables restart of an operation in case of a disruption or other failure.

In some systems, for example in UNIX-style file systems, data is handled with an index node or inode, which specifies a data structure that represents an object in a file system. The object could be a file or a directory, for example. Metadata may accompany the object, as attributes such as permission data and a creation timestamp, among other attributes. A segment number could be assigned to all or a portion of such an object in a file system. In other systems, data segments are handled with a segment number assigned elsewhere. For purposes of discussion, the unit of distribution is an entity, and an entity can be a file, a directory or a segment. That is, entities are units of data or metadata stored by a storage system. Entities are grouped into sets called authorities. Each authority has an authority owner, which is a storage node that has the exclusive right to update the entities in the authority. In other words, a storage node contains the authority, and that the authority, in turn, contains entities.

A segment is a logical container of data in accordance with some embodiments. A segment is an address space between medium address space and physical flash locations, i.e., the data segment number, are in this address space. Segments may also contain meta-data, which enable data redundancy to be restored (rewritten to different flash locations or devices) without the involvement of higher level software. In one embodiment, an internal format of a segment contains client data and medium mappings to determine the position of that data. Each data segment is protected, e.g., from memory and other failures, by breaking the segment into a number of data and parity shards, where applicable. The data and parity shards are distributed, i.e., striped, across non-volatile solid state storage 1452 coupled to the host CPUs 1456 in accordance with an erasure coding scheme. Usage of the term segments refers to the container and its place in the address space of segments in some embodiments. Usage of the term stripe refers to the same set of shards as a segment and includes how the shards are distributed along with redundancy or parity information in accordance with some embodiments.

A series of address-space transformations takes place across an entire storage system. At the top are the directory entries (file names) which link to an inode. Modes point into medium address space, where data is logically stored. Medium addresses may be mapped through a series of indirect mediums to spread the load of large files, or implement data services like deduplication or snapshots. Medium addresses may be mapped through a series of indirect mediums to spread the load of large files, or implement data services like deduplication or snapshots. Segment addresses are then translated into physical flash locations. Physical flash locations have an address range bounded by the amount of flash in the system in accordance with some embodiments. Medium addresses and segment addresses are logical containers, and in some embodiments use a 128 bit or larger identifier so as to be practically infinite, with a likelihood of reuse calculated as longer than the expected life of the system. Addresses from logical containers are allocated in a hierarchical fashion in some embodiments. Initially, each non-volatile solid state storage 1452 unit may be assigned a range of address space. Within this assigned range, the non-volatile solid state storage 1452 is able to allocate addresses without synchronization with other non-volatile solid state storage 1452.

Data and metadata is stored by a set of underlying storage layouts that are optimized for varying workload patterns and storage devices. These layouts incorporate multiple redundancy schemes, compression formats and index algorithms. Some of these layouts store information about authorities and authority masters, while others store file metadata and file data. The redundancy schemes include error correction codes that tolerate corrupted bits within a single storage device (such as a NAND flash chip), erasure codes that tolerate the failure of multiple storage nodes, and replication schemes that tolerate data center or regional failures. In some embodiments, low density parity check (‘LDPC’) code is used within a single storage unit. Reed-Solomon encoding is used within a storage cluster, and mirroring is used within a storage grid in some embodiments. Metadata may be stored using an ordered log structured index (such as a Log Structured Merge Tree), and large data may not be stored in a log structured layout.

In order to maintain consistency across multiple copies of an entity, the storage nodes agree implicitly on two things through calculations: (1) the authority that contains the entity, and (2) the storage node that contains the authority. The assignment of entities to authorities can be done by pseudo randomly assigning entities to authorities, by splitting entities into ranges based upon an externally produced key, or by placing a single entity into each authority. Examples of pseudorandom schemes are linear hashing and the Replication Under Scalable Hashing (‘RUSH’) family of hashes, including Controlled Replication Under Scalable Hashing (‘CRUSH’). In some embodiments, pseudo-random assignment is utilized only for assigning authorities to nodes because the set of nodes can change. The set of authorities cannot change so any subjective function may be applied in these embodiments. Some placement schemes automatically place authorities on storage nodes, while other placement schemes rely on an explicit mapping of authorities to storage nodes. In some embodiments, a pseudorandom scheme is utilized to map from each authority to a set of candidate authority owners. A pseudorandom data distribution function related to CRUSH may assign authorities to storage nodes and create a list of where the authorities are assigned. Each storage node has a copy of the pseudorandom data distribution function, and can arrive at the same calculation for distributing, and later finding or locating an authority. Each of the pseudorandom schemes requires the reachable set of storage nodes as input in some embodiments in order to conclude the same target nodes. Once an entity has been placed in an authority, the entity may be stored on physical devices so that no expected failure will lead to unexpected data loss. In some embodiments, rebalancing algorithms attempt to store the copies of all entities within an authority in the same layout and on the same set of machines.

Examples of expected failures include device failures, stolen machines, datacenter fires, and regional disasters, such as nuclear or geological events. Different failures lead to different levels of acceptable data loss. In some embodiments, a stolen storage node impacts neither the security nor the reliability of the system, while depending on system configuration, a regional event could lead to no loss of data, a few seconds or minutes of lost updates, or even complete data loss.

In the embodiments, the placement of data for storage redundancy is independent of the placement of authorities for data consistency. In some embodiments, storage nodes that contain authorities do not contain any persistent storage. Instead, the storage nodes are connected to non-volatile solid state storage units that do not contain authorities. The communications interconnect between storage nodes and non-volatile solid state storage units consists of multiple communication technologies and has non-uniform performance and fault tolerance characteristics. In some embodiments, as mentioned above, non-volatile solid state storage units are connected to storage nodes via PCI express, storage nodes are connected together within a single chassis using Ethernet backplane, and chassis are connected together to form a storage cluster. Storage clusters are connected to clients using Ethernet or fiber channel in some embodiments. If multiple storage clusters are configured into a storage grid, the multiple storage clusters are connected using the Internet or other long-distance networking links, such as a “metro scale” link or private link that does not traverse the internet.

Authority owners have the exclusive right to modify entities, to migrate entities from one non-volatile solid state storage unit to another non-volatile solid state storage unit, and to add and remove copies of entities. This allows for maintaining the redundancy of the underlying data. When an authority owner fails, is going to be decommissioned, or is overloaded, the authority is transferred to a new storage node. Transient failures make it non-trivial to ensure that all non-faulty machines agree upon the new authority location. The ambiguity that arises due to transient failures can be achieved automatically by a consensus protocol such as Paxos, hot-warm failover schemes, via manual intervention by a remote system administrator, or by a local hardware administrator (such as by physically removing the failed machine from the cluster, or pressing a button on the failed machine). In some embodiments, a consensus protocol is used, and failover is automatic. If too many failures or replication events occur in too short a time period, the system goes into a self-preservation mode and halts replication and data movement activities until an administrator intervenes in accordance with some embodiments.

As authorities are transferred between storage nodes and authority owners update entities in their authorities, the system transfers messages between the storage nodes and non-volatile solid state storage units. With regard to persistent messages, messages that have different purposes are of different types. Depending on the type of the message, the system maintains different ordering and durability guarantees. As the persistent messages are being processed, the messages are temporarily stored in multiple durable and non-durable storage hardware technologies. In some embodiments, messages are stored in RAM, NVRAM and on NAND flash devices, and a variety of protocols are used in order to make efficient use of each storage medium. Latency-sensitive client requests may be persisted in replicated NVRAM, and then later NAND, while background rebalancing operations are persisted directly to NAND.

Persistent messages are persistently stored prior to being transmitted. This allows the system to continue to serve client requests despite failures and component replacement. Although many hardware components contain unique identifiers that are visible to system administrators, manufacturer, hardware supply chain and ongoing monitoring quality control infrastructure, applications running on top of the infrastructure address virtualize addresses. These virtualized addresses do not change over the lifetime of the storage system, regardless of component failures and replacements. This allows each component of the storage system to be replaced over time without reconfiguration or disruptions of client request processing, i.e., the system supports non-disruptive upgrades.

In some embodiments, the virtualized addresses are stored with sufficient redundancy. A continuous monitoring system correlates hardware and software status and the hardware identifiers. This allows detection and prediction of failures due to faulty components and manufacturing details. The monitoring system also enables the proactive transfer of authorities and entities away from impacted devices before failure occurs by removing the component from the critical path in some embodiments.

FIG. 14C is a multiple level block diagram, showing contents of a storage node 1450 and contents of a non-volatile solid state storage 1452 of the storage node 1450. Data is communicated to and from the storage node 1450 by a network interface controller (‘NIC’) 202 in some embodiments. Each storage node 1450 has a CPU 1456, and one or more non-volatile solid state storage 1452, as discussed above. Moving down one level in FIG. 14C, each non-volatile solid state storage 1452 has a relatively fast non-volatile solid state memory, such as nonvolatile random access memory (‘NVRAM’) 1404, and flash memory 1406. In some embodiments, NVRAM 1404 may be a component that does not require program/erase cycles (DRAM, MRAM, PCM), and can be a memory that can support being written vastly more often than the memory is read from. Moving down another level in FIG. 14C, the NVRAM 1404 is implemented in one embodiment as high speed volatile memory, such as dynamic random access memory (DRAM) 1416, backed up by energy reserve 1418. Energy reserve 1418 provides sufficient electrical power to keep the DRAM 1416 powered long enough for contents to be transferred to the flash memory 1406 in the event of power failure. In some embodiments, energy reserve 1418 is a capacitor, super-capacitor, battery, or other device, that supplies a suitable supply of energy sufficient to enable the transfer of the contents of DRAM 1416 to a stable storage medium in the case of power loss. The flash memory 1406 is implemented as multiple flash dies 1422, which may be referred to as packages of flash dies 1422 or an array of flash dies 1422. It should be appreciated that the flash dies 1422 could be packaged in any number of ways, with a single die per package, multiple dies per package (i.e., multichip packages), in hybrid packages, as bare dies on a printed circuit board or other substrate, as encapsulated dies, etc. In the embodiment shown, the non-volatile solid state storage 1452 has a controller 1412 or other processor, and an input output (I/O) port 1410 coupled to the controller 1412. I/O port 1410 is coupled to the CPU 1456 and/or the network interface controller 202 of the flash storage node 1450. Flash input output (I/O) port 1420 is coupled to the flash dies 1422, and a direct memory access unit (DMA) 1414 is coupled to the controller 1412, the DRAM 1416 and the flash dies 1422. In the embodiment shown, the I/O port 1410, controller 1412, DMA unit 1414 and flash I/O port 1420 are implemented on a programmable logic device (‘PLD’) 208, e.g., an FPGA. In this embodiment, each flash die 1422 has pages, organized as sixteen kB (kilobyte) pages 224, and a register 226 through which data can be written to or read from the flash die 1422. In further embodiments, other types of solid-state memory are used in place of, or in addition to flash memory illustrated within flash die 1422.

Storage clusters 1461, in various embodiments as disclosed herein, can be contrasted with storage arrays in general. The storage nodes 1450 are part of a collection that creates the storage cluster 1461. Each storage node 1450 owns a slice of data and computing required to provide the data. Multiple storage nodes 1450 cooperate to store and retrieve the data. Storage memory or storage devices, as used in storage arrays in general, are less involved with processing and manipulating the data. Storage memory or storage devices in a storage array receive commands to read, write, or erase data. The storage memory or storage devices in a storage array are not aware of a larger system in which they are embedded, or what the data means. Storage memory or storage devices in storage arrays can include various types of storage memory, such as RAM, solid state drives, hard disk drives, etc. The non-volatile solid state storage 1452 units described herein have multiple interfaces active simultaneously and serving multiple purposes. In some embodiments, some of the functionality of a storage node 1450 is shifted into a storage unit 1452, transforming the storage unit 1452 into a combination of storage unit 1452 and storage node 1450. Placing computing (relative to storage data) into the storage unit 1452 places this computing closer to the data itself. The various system embodiments have a hierarchy of storage node layers with different capabilities. By contrast, in a storage array, a controller owns and knows everything about all of the data that the controller manages in a shelf or storage devices. In a storage cluster 1461, as described herein, multiple controllers in multiple non-volatile sold state storage 1452 units and/or storage nodes 1450 cooperate in various ways (e.g., for erasure coding, data sharding, metadata communication and redundancy, storage capacity expansion or contraction, data recovery, and so on).

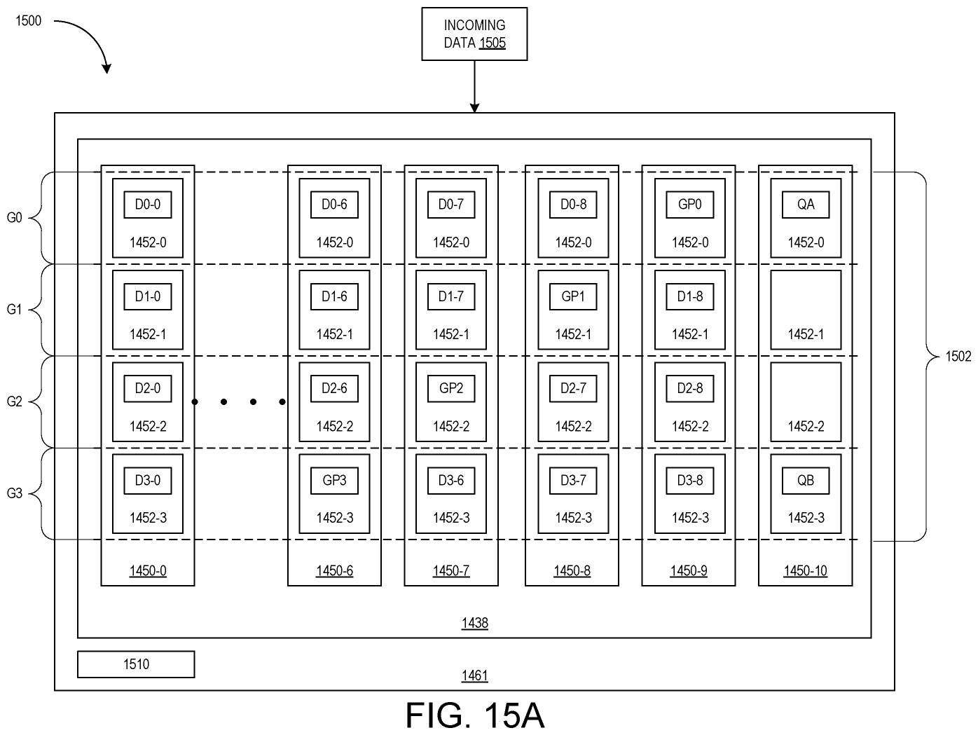

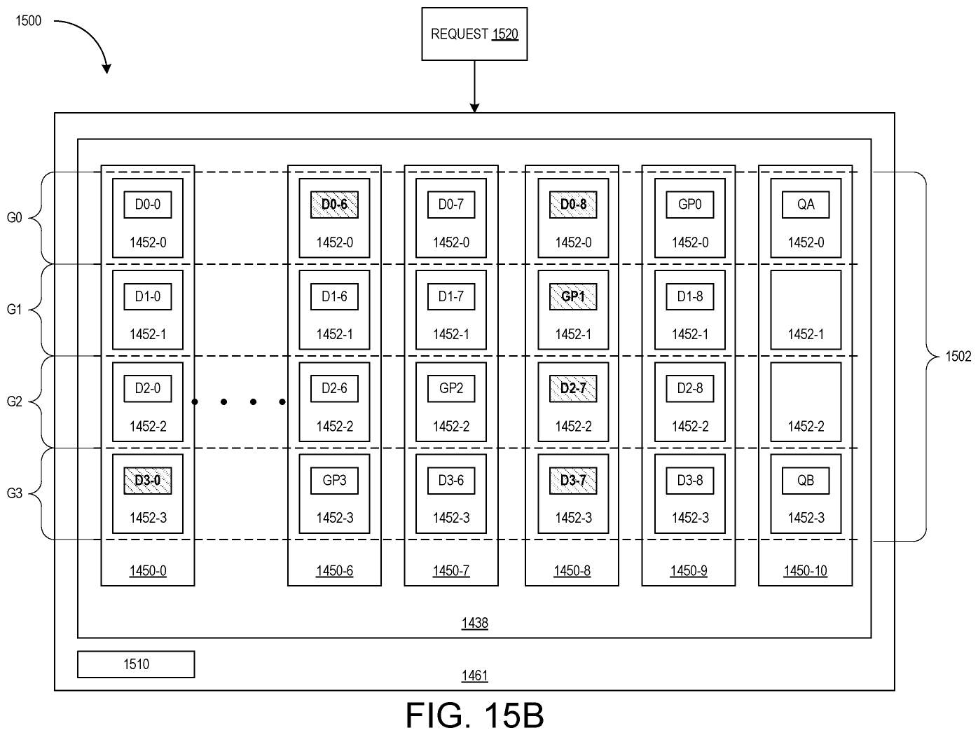

FIG. 15A block diagram, showing contents of a storage system 1500 in accordance with some embodiments. The storage system 1500 includes a storage cluster 1461. The storage cluster 1461 includes a processor 1510 (e.g., a CPU, an ASIC, a processing device, etc.). The storage cluster 1461 also includes a chassis 1438 (e.g., housing, enclosure, rack unit, etc.) which may have multiple slots. The storage cluster 1461 further includes storage nodes 1450-0 through 1450-10 (e.g., eleven storage nodes). Each storage node 1450-0 through 1450-10 may be located in one of the multiple slots of the chassis 1438. Each storage node 1450-0 through 1450-10 may generally be referred to as storage node 1450. Each storage node 1450 may have multiple components (e.g., a PCB, CPU, RAM, non-volatile memory, etc.). As further explained below, each storage node 1450 includes non-volatile solid state storage 1452-0 through 1452-3. The storage cluster 1461 may be scalable (e.g., storage capacity with non-uniform storage sizes is readily added). For example, each storage node 1450 may be removable from the storage system 1500. The storage system 1500 may also be referred to as a data storage system.

The non-volatile solid state storage 1452-0 through 1452-3 may referred to as non-volatile memory units. In one embodiment, the non-volatile memory units (e.g., 1452-0 through 1452-3) illustrated in FIG. 15 may be removable from the storage nodes where they are located (e.g., installed, plugged in, coupled to, etc.). For example, the non-volatile memory units 1452 may be flash chips (e.g., removable flash chips), solid state drives, M.2 drives, NVME drives, etc. The non-volatile memory units 1452-0 through 1452 may be referred to generally as non-volatile memory units 1452.

In one embodiment, the storage system 1500 (e.g., a data storage system) may receive incoming data 1505. For example, the data storage system may receive the incoming data 1505 (from another computing device or client device) via a network. The incoming data 1505 may be destined, intended, for the storage system 1500. For example, a client device may transmit the incoming data 1505 to the storage system 1500 to store the incoming data 1505 within the storage system 1500.

In one embodiment, the storage system 1500 may store the incoming data 1505 as a redundant array of independent drives (RAID) stripe 1502 within the storage system 1500 storage system. For example, storage system 1500 may generate, create, etc., the RAID stripe 1502 that includes the incoming data 1505. The storage system 1500 may also store the RAID stripe 1502 (e.g., portions, parts, etc., of the RAID stripe 1502) in the storage nodes 1450 and/or the non-volatile solid state storage 1452, as discussed in more detail below.

In one embodiment, the storage system 1500 may divide the incoming data 1505 into data shards. A data shard may refer to a portion of the incoming data 1505. For example, the storage system 1500 may divide the incoming data into thirty-six data shards (e.g., data shards D0-0 through D0-8, data shards D1-0 through D1-8, data shards D2-0 through D2-8, and data shards D3-0 through D3-8).

In one embodiment, the storage system 1500 may group the data shards into groups (e.g., sets) of data shards. For example, the storage system 1500 may group data shards D0-0 through D0-8 in a first group G0, data shards D1-0 through D1-8 into a second group G1, data shards D2-0 through D2-8 into a third group G2, and data shards D3-0 through D3-8 into a fourth group G3. A group of data shards may also be referred to as a data shard group.

In one embodiment, the storage system 1500 may generate (e.g., create, calculate, obtain, etc.) a group parity shard for each group of data shards. For example, the storage system 1500 may generate group parity shard GP0 for group G0, generate group parity shard GP1 for group G1, generate group parity shard GP2 for group G2, and generate group parity shard GP3 for group G3. A group parity shard may be an XOR parity (e.g., parity data) that is calculated, determined, generated, etc., for the data shards in a group. A group parity shard may allow a data shard for a group to be recovered (e.g., recalculated, reconstructed, etc.) if the data shard is inaccessible (e.g., lost, corrupted, damaged, etc.). For example, if data shard D0-0 is inaccessible, the data shard D0-0 may be recovered using data shards D0-1 through D0-8 and group parity shard GP0. Each group of data shards G0 through G3 may also include a group parity shard for the group. For example, group G0 includes a group parity shard GP0, group G1 includes a group parity shard GP1, group G2 includes a group parity shard GP2, and group G3 includes a group parity shard GP3.

In one embodiment, the storage system 1500 may also generate (e.g., create, calculate, obtain, etc.) a set of stripe parity shards (e.g., one or more stripe parity shards). The set of stripe parity shards may be generated based on all of the data shards D0-0 through D3-8 in the RAID strip 1502. A stripe parity shard may allow a data shard to be recovered (e.g., recalculated, reconstructed, etc.) if the data shard is inaccessible (e.g., lost, corrupted, damaged, etc.).

In one embodiment, the storage node 1450-10 stores the stripe parity shards QA and QB on separate non-volatile memory units. For example, stripe parity shard QA is stored on non-volatile memory unit 1452-0 (of storage node 1450-10) and stripe parity shard QB is stored on non-volatile memory unit 1452-3 (of storage node 1450-10). In addition, the storage node 1450-10 (e.g., the storage node where the stripe parity shards are stored) may not store any group parity shards and may not store any data shards.

As illustrated in FIG. 15, each of the storage nodes 1450-0 through 1450-9 (e.g., the remaining storage nodes in the storage system 1500) stores one data shard from each group, or one of the of the group parity shards. The data shards D0-0 through D3-8 are arranged within the storage nodes 1450 and/or the non-volatile memory units 1452 in an arrangement/layout that allows the storage system 1500 to recover data shards when one or more data shards are inaccessible, as discussed in more detail below. For example, storage node 1450-0 stores one data shard from group G0 (e.g., D0-0), one data shard from group G1 (e.g., D1-0), one data shard from group G2 (e.g., D2-0), and one data shard from group G3 (e.g., D3-0). In one embodiment, each of storage nodes 1450-0 through 1450-9 store at most one data shard from each group or a group parity shard for a group. For example, each of storage nodes 1450-0 through 1450-9 stores one data shard or a group parity shard for group G0, one data shard or a group parity shard for group G1, one data shard or a group parity shard for group G2, and one data shard or a group parity shard for group G3. The storage nodes 1450-0 through 1450-9 do not store the stripe parity shards QA and QB.

In one embodiment, the storage system 1500 is able to recover a data and/or data shards in the RAID stripe 1502 when as many as six data shards are inaccessible. For example, the storage system 1500 may be able to recover and/or provide access to data shards, if one data shard from each group G0 through G3 is inaccessible and two additional data shards are also inaccessible. Because the data shards are arranged or laid out within the storage nodes 1450 such that each storage node stores at most one data shard group parity shard from a group, the storage system 1500 is still able to recover data shards when one data shard from each group G0 through G3 is inaccessible (e.g., four data shards) and an additional two data shards are also inaccessible. For example, if all of the parity shards (e.g., group parity shards and/or strip parity shards) are available and six total data shards are inaccessible, the storage system 1500 may still be able to recover the data shards.

FIG. 15B block diagram, showing contents of a storage system 1500 in accordance with some embodiments. As discussed above, the storage system 1500 includes a storage cluster 1461 and the storage cluster 1461 includes a chassis 1438 (e.g., housing, enclosure, rack unit, etc.) which may have multiple slots. Each storage node 1450-0 through 1450-10 may be located in one of the multiple slots of the chassis 1438. Each storage node 1450 includes non-volatile memory units 1452-0 through 1452-3, as well as other components (e.g., CPU, RAM, etc.).

In one embodiment, the storage system 1500 may receive a request for a data shard of a group of data shards stored (e.g., located, residing, etc.) on a storage node. For example, the storage system 1500 may receive a request 1520 (from a client/computing device and via a network) to access data shard D2-7 of group G2. Data shard D2-7 is stored in non-volatile memory unit 1452-2 of storage node 1450-8. Storage node 1450-8 also includes (e.g., also stores) data shards D0-8 (of group G0), group parity shard GP1 (of group G1), and data shard D3-7 (of group G3).

As discussed above, one or more data shards of the RAID stripe 1502 may be inaccessible. For example, storage node 1450-8 may be inoperable (e.g., crashed, reset, malfunctioned, etc.) and all of the data shards (e.g., data shards D0-8, D2-7, and D3-7) and/or group parity shards (e.g., group parity shard GP1) located (e.g., stored) on storage node 1450-8 may be inaccessible. In addition, two additional data shards D0-6 and D3-0 may also be inaccessible. For example, the non-volatile memory units 1452 that store data shards D0-6 and D3-0 may be inoperable.

In one embodiment, storage system 1500 may determine that the data shard D2-7 (of group G2) is inaccessible (e.g., offline, damaged, corrupted, etc.). For example, the storage system 1500 may determine that the storage node 1450-8 is inoperable (e.g., has crashed, has reset, has malfunctioned, or is otherwise unable to provide/access to the requested data shard). The storage system 1500 may determine that the node 1450-8 is inoperable, if the storage node 1450-8 is unresponsive, if the storage node 1450-8 does not respond to messages/signals, if the storage node 1450-8 indicates that it is experiencing problems/issues, etc. In another example, the storage system 1500 may determine that non-volatile memory unit 1452-2 is inaccessible (e.g., the storage node 1450-8 is operable overall, but non-volatile memory unit 1452-2 is inaccessible). The storage system 1500 may reconstruct (e.g., regenerate, recreate, etc.) the data shard D2-7 using the other data shards in the group G2 (e.g., data shards D2-0 through D2-6 and D2-8) and the group parity shard GP2. This may allow the storage system 1500 to provide access to the data shard D2-7 (or a copy/reconstruction of data shard D2-7) even though the data shard D2-7 is not accessible.

As discussed above, the storage system 1500 may determine that one or more data shards are inaccessible, damaged, corrupted, etc. For example, the data shard D2-7 (of group G2) is inaccessible (as illustrated in FIG. 15B). In one embodiment, the storage system 1500 may determine whether one or more of the data shards that are inaccessible can be relocated to another storage node in the storage system 1500. For example, the storage system 1500 may determine that the storage node may determine which non-volatile memory units 1452 in the storage node 1450-10 are not storing data shards, group parity shards, and/or stripe parity shards. For example, storage system 1500 may determine that storage node 1450-8 is inoperable. The storage system 1500 may also determine that data shard D2-7 may be relocated from non-volatile memory unit 1452-2 of storage node 1450-8, to storage node 1450-10. The storage system 1500 may transmit a message (or some other indication) to another computing device, indicating that data shard D2-7 may be relocated to storage node 1450-10. For example, the storage system 1500 may transmit a chat message, an email, a text message, etc., to a computing device of an administrator (e.g., a system administrator) for storage system 1500. The message may also include an identifier for the non-volatile memory unit where the first data shard is located, an identifier for the storage node where the first data shard is located, and/or an identifier for the destination storage node.

In one embodiment, the data shard D2-7 may be relocated to storage node 1450-10 when the non-volatile memory unit 1452-2 of storage node 1450-8 is moved to storage node 1450-10. For example, the non-volatile memory unit 1452-2 of storage node 1450-8 may replace the non-volatile memory unit 1452-2 of storage node 1450-10 (e.g., the non-volatile memory unit 1452-2 of storage node 1450-10 may be swapped out and replaced with the non-volatile memory unit 1452-2 of storage node 1450-8). The storage system 1500 may be able to provide access to the data shard D2-7 without reconstructing the data shards D2-7 after it has been relocated to the storage node 1450-10.

As discussed above, the storage system 1500 is able to recover a data and/or data shards in the RAID stripe 1502 when as many as six data shards are inaccessible. For example, the storage system 1500 may be able to recover and/or provide access to data shards, if one data shard from each group G0 through G3 is inaccessible and two additional data shards are also inaccessible. Because the data shards are arranged or laid out within the storage nodes 1450 such that each storage node stores at most one data shard group parity shard from a group, the storage system 1500 is still able to recover data shards when one data shard from each group G0 through G3 is inaccessible (e.g., four data shards) and an additional two data shards are also inaccessible.

Because the storage system 1500 is able to recover data shards when one data shard from each group G0 through G3 is inaccessible (due to the arrangement/layout of the data shards), the storage system 1500 is able to recover data shards and continue to service access requests (e.g., provide access to requested data shards) when certain relatively common failures occur (e.g., failures that may up a certain percentage/amount of all failures). For example, the failure of a storage node 1450 may be a common failure. A failed or inoperable storage node 1450 may be removed from the storage system 1500 and replaced with new storage node 1450. Before the failed storage node 1450 is replaced, the storage system 1500 is still able to provide access to data shards that were stored on the filed storage node 1450. In addition, the arrangement or layout of the data shards (as illustrated in FIGS. 15A and 15B) allow for faster reconstruction of the data shards. For example, if only one data shard for a group is inaccessible, the storage system 1500 may read the other data shards in the group and the group parity shard to recover the one data shard, rather than reading data shards from other groups and/or the stripe parity shards. A failed or inoperable storage node may also be fixed by restarting, resetting, rebooting, etc., the failed/inoperable node. The arrangement of layout of the data shards (as illustrated in FIGS. 15A and 15B) may allow the storage system to continue providing access to the data shards while the failed/inoperable storage node is rebooted.

Although FIGS. 15A and 15B illustrate a storage cluster 1461 that includes a single chassis 1438, multiple chassis may be used in the storage system 1500. For example, the storage cluster 1461 may include two, five, or any appropriate number of chassis, and each chassis may include its own set of storage nodes (e.g., each chassis may include eleven storage nodes). The number of data shards, group parity shards, and/or stripe parity shards, may be different if the number of chassis and/or storage nodes 1450 increases. For example, if there are two chassis 1461 and twenty-two storage nodes 1450, then incoming data may be divided into eight groups shards, each group shards including nine data shards and one group parity shard, and four stripe parity shards. The first chassis 1461 may store data shards and group parity shards for the first four groups and the second chassis 1461 may store data shards and group parity shards for the second four groups. The strip parity shards may be divided across the storage nodes in the first and second chassis 1461 that are not storing data shards. In addition, the storage system may be able to recover more data shards when compared to the examples illustrated in FIGS. 15A and 15B, if there are more chassis and more storage nodes in the storage system. For example, a storage system may be able to recover eight, twelve, or some other appropriate number of data shards when the storage system includes multiple chassis (and more storage nodes).

In addition, the operations, processes, actions, methods, etc., described herein may be performed by a processor of one or more storage nodes 1450 (e.g., CPU 1456 illustrated in FIG. 14A) and/or may be performed by process 1510. For example, operations, processes, actions, methods, etc., may be divided among the CPUs 1456 of the storage nodes 1450-0 through 1450-10. In another example, one CPU 1456 of one storage node 1450 or the process 1510 may perform the operations, processes, actions, methods, etc., described herein.

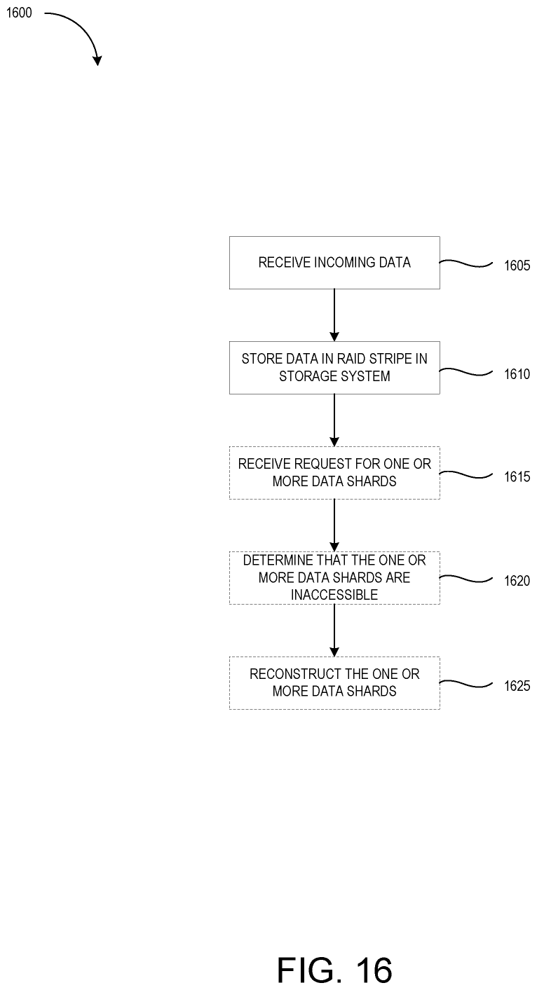

FIG. 16 is a generalized flow diagram illustrating one embodiment of a method 1600 for storing data in a storage system in accordance with some embodiments. Method 1600 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 1600 may be performed by one or more of a storage system, a processor, etc., as illustrated in various figures (e.g., one or more of FIGS. 1-15B).

With reference to FIG. 16, method 1600 illustrates example functions used by various embodiments. Although specific function blocks (“blocks”) are disclosed in method 1600, such blocks are examples. That is, embodiments are well suited to performing various other blocks or variations of the blocks recited in method 1600. It is appreciated that the blocks in method 1600 may be performed in an order different than presented, and that not all of the blocks in method 1600 may be performed, and other blocks (which may not be included in FIG. 16) may be performed between the blocks illustrated in FIG. 16.

The method 1600 begins at block 1605 where method 1600 receives incoming data to be stored in the data storage system. For example, the incoming data may be a one or more files received from a client device (e.g., laptop computer, a smart phone, a tablet, etc.) via a network. At block 1610, the method 1600 may store the incoming data as a RAID stripe in the data storage system. The method 1600 may generate the RAID strip by dividing the incoming data into data shards. The data shards may be grouped together to form groups of data shards. The method 1600 may also generate group parity shards for the groups of data shards, and stripe parity shards for the RAID stripe.

At block 1615, the method 1600 may optionally receive a request for one or more data shards of the RAID stripe. For example, the client device that requested to store the incoming data on the data storage system may request the one or more data shards. In another example, another client device may request the one or more data shards. At block 1620, the method 1600 may optionally determine that the one or more data shards are inaccessible. For example, the method 1600 may determine that the storage node where the one or more data shards are stored, is inoperable (e.g., has crashed, is rebooting, etc.). In another example, the method 1600 may determine that one or more non-volatile memory units where the one or more data shards are stored, are inoperable (e.g., has malfunctioned). At block 1625, the method 1600 may reconstruct the one or more data shards. For example, the method 1600 may reconstruct the one or more data shards using group parity shards and/or stripe parity shards, as discussed above.

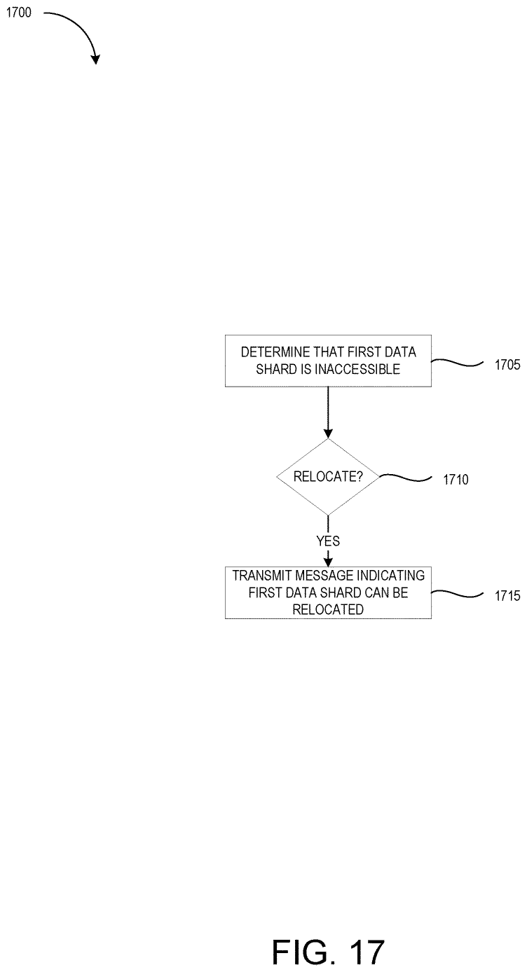

FIG. 17 is a generalized flow diagram illustrating one embodiment of a method 1700 for relocating data shards in a storage system in accordance with some embodiments. Method 1700 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 1700 may be performed by one or more of a storage system, a processor, etc., as illustrated in various figures (e.g., one or more of FIGS. 1-15B).

With reference to FIG. 17, method 1700 illustrates example functions used by various embodiments. Although specific function blocks (“blocks”) are disclosed in method 1700, such blocks are examples. That is, embodiments are well suited to performing various other blocks or variations of the blocks recited in method 1700. It is appreciated that the blocks in method 1700 may be performed in an order different than presented, and that not all of the blocks in method 1700 may be performed, and other blocks (which may not be included in FIG. 17) may be performed between the blocks illustrated in FIG. 17.

The method 1700 begins at block 1705 where method 1700 may determine that a first data shard is inaccessible. For example, the method 1700 may determine that the storage node where the first data shard is stored, is inoperable (e.g., has crashed, is rebooting, etc.). At block 1710, the method 1700 may determine whether the first data shard can be relocated. For example, the method 1700 may determine whether the non-volatile memory unit where the first data shard is stored, can be moved to another storage node. In another example, the method 1700 may determine whether the non-volatile memory unit where the first data shard is stored can be swapped into another storage node (e.g., can replace an existing non-volatile memory unit in the other storage node). If the first data shard can be relocated to another storage node, the method 1700 may transmit a message indicating that the first data shard can be relocated at block 1715. For example, the method 1700 may transmit a message to a device (e.g., a computing device of an administrator) indicating that the first data shard can be relocated to another storage node. The message may also include an identifier for the non-volatile memory unit where the first data shard is located, an identifier for the storage node where the first data shard is located, and/or an identifier for the destination storage node.

It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

Although the embodiments above have been described in considerable detail, numerous variations and modifications will become apparent to those skilled in the art once the above disclosure is fully appreciated. It is intended that the following claims be interpreted to embrace all such variations and modifications.

Advantages and features of the present disclosure can be further described by the following statements:

1. A method, comprising:

receiving incoming data to be stored in a data storage system comprising a plurality of storage nodes, wherein each storage node comprises a plurality of non-volatile memory modules;

and storing the incoming data in a redundant array of independent drives (RAID) stripe in the data storage system, wherein:

the RAID stripe comprises groups of data shards;

each group of data shards and a respective group parity shard are stored across the plurality of nodes of the data storage system; and

a set of stripe parity shards are stored in a first storage node of the plurality of storage nodes.

2. The method of claim 1, wherein each storage node stores one of a data shard from each group of data shards, a group parity shard for a respective group of data shards, or a stripe parity shard.

3. The method of claim 1, wherein the groups of data shards are not stored on the first storage node.

4. The method of claim 1, wherein the plurality of storage nodes are distributed across multiple chassis of the data storage system.

5. The method of claim 1, further comprising:

receiving a request for a first data shard of a first group of data shards stored on the one storage node;

determining that the first data shard is inaccessible; and

reconstructing the first data shard based on remaining data shards of the first group of data shards and a first group parity shard for the first group of data shards.

6. The method of claim 5, wherein determining that the first data shard is inaccessible comprises:

determining that a first storage node of the plurality of storage nodes is inoperable, wherein the first data shard is stored on the one storage node.

7. The method of claim 1, further comprising:

providing access to first data shards while the first storage node is rebooted.

8. The method of claim 1, further comprising:

determining that one or more data shards are inaccessible;

determining whether the one or more data shards can be relocated to the first storage node; and

transmitting a message indicating that the one or more data shards can be relocated to the first storage node.

9. The method of claim 1, wherein the storage system is configured to recover data shards when one data shard from each group is inaccessible and when one or more additional data shards are inaccessible.

10. The method of claim 1, wherein the storage system is configured to recover data shards when one or more storage nodes are inaccessible.

11. The method of claim 1, further comprising:

generating the respective group parity shards for each group of data shards based on the incoming data; and

generating the set of stripe parity shards based on the incoming data.

12. A storage system, comprising:

a plurality of storage nodes, each storage node of the plurality of storage nodes comprising a plurality of non-volatile memory modules; and

a processor operatively coupled to the plurality of storage nodes, to perform a method, comprising:

receiving incoming data; and

storing the incoming data in a redundant array of independent drives (RAID) stripe in the data storage system, wherein:

the RAID stripe comprises groups of data shards;

each group of data shards and a respective group parity shard are stored across the plurality of nodes of the data storage system; and

a set of stripe parity shards are stored in a first storage node of the plurality of storage nodes.

13. The storage system of claim 12, wherein each storage node stores one of a data shard from each group of data shards, a group parity shard for a respective group of data shards, or a stripe parity shard.

14. The storage system of claim 12, wherein the groups of data shards are not stored on the first storage node.

15. The storage system of claim 12, wherein the plurality of storage nodes are distributed across multiple chassis of the data storage system.

16. The storage system of claim 12, wherein the processing device is further configured to:

receive a request for a first data shard of a first group of data shards stored on the one storage node;

determine that the first data shard is inaccessible; and

reconstruct the first data shard based on remaining data shards of the first group of data shards and a first group parity shard for the first group of data shards.

17. The storage system of claim 16, wherein to determine that the first data shard is inaccessible the processing device is further configured to:

determine that one storage node of the plurality of storage nodes is inoperable, wherein the first data shard is stored on the one storage node.

18. The storage system of claim 12, wherein the processing device is further configured to:

determine that one or more data shards are inaccessible;

determine whether the one or more data shards can be relocated to the first storage node;

and transmit a message indicating that the one or more data shards can be relocated to the first storage node.

19. The storage system of claim 12, wherein the processing device is further configured to:

recover data shards when one data shard from each group is inaccessible and when one or more additional data shards are inaccessible.

20. A non-transitory, computer-readable media having instructions thereupon which, when executed by a processor, cause the processor to perform a method comprising: receiving incoming data to be stored in a data storage system comprising a plurality of storage nodes, wherein each storage node comprises a plurality of non-volatile memory modules; and storing the incoming data in a redundant array of independent drives (RAID) stripe in the data storage system, wherein:

the RAID stripe comprises groups of data shards;

each group of data shards and a respective group parity shard are stored across the plurality of nodes of the data storage system; and

a set of stripe parity shards are stored in a first storage node of the plurality of storage nodes.

What is claimed is:

1. A method, comprising:
receiving incoming data to be stored in a data storage system comprising a plurality of storage nodes, wherein each storage node comprises a plurality of non-volatile memory modules; and
storing the incoming data in a redundant array of independent drives (RAID) stripe in the data storage system, wherein:
the RAID stripe comprises groups of data shards;
each group of data shards and a respective group parity shard are stored across the plurality of nodes of the data storage system; and
a set of stripe parity shards are stored in a first storage node of the plurality of storage nodes.

2. The method of claim 1, wherein each storage node stores one of a data shard from each group of data shards, a group parity shard for a respective group of data shards, or a stripe parity shard.

3. The method of claim 1, wherein the groups of data shards are not stored on the first storage node.

4. The method of claim 1, wherein the plurality of storage nodes are distributed across multiple chassis of the data storage system.

5. The method of claim 1, further comprising:
receiving a request for a first data shard of a first group of data shards stored on the one storage node;
determining that the first data shard is inaccessible; and
reconstructing the first data shard based on remaining data shards of the first group of data shards and a first group parity shard for the first group of data shards.

6. The method of claim 5, wherein determining that the first data shard is inaccessible comprises:
determining that a first storage node of the plurality of storage nodes is inoperable, wherein the first data shard is stored on the one storage node.

7. The method of claim 1, further comprising:
providing access to first data shards while the first storage node is rebooted.

8. The method of claim 1, further comprising:
determining that one or more data shards are inaccessible;
determining whether the one or more data shards can be relocated to the first storage node; and
transmitting a message indicating that the one or more data shards can be relocated to the first storage node.

9. The method of claim 1, wherein the storage system is configured to recover data shards when one data shard from each group is inaccessible and when one or more additional data shards are inaccessible.

10. The method of claim 1, wherein the storage system is configured to recover data shards when one or more storage nodes are inaccessible.

11. The method of claim 1, further comprising:
generating the respective group parity shards for each group of data shards based on the incoming data; and
generating the set of stripe parity shards based on the incoming data.

12. A storage system, comprising:
a plurality of storage nodes, each storage node of the plurality of storage nodes comprising a plurality of non-volatile memory modules; and
a processor operatively coupled to the plurality of storage nodes, to perform a method, comprising:
receiving incoming data; and
storing the incoming data in a redundant array of independent drives (RAID) stripe in the data storage system, wherein:
the RAID stripe comprises groups of data shards;
each group of data shards and a respective group parity shard are stored across the plurality of nodes of the data storage system; and
a set of stripe parity shards are stored in a first storage node of the plurality of storage nodes.

13. The storage system of claim 12, wherein each storage node stores one of a data shard from each group of data shards, a group parity shard for a respective group of data shards, or a stripe parity shard.

14. The storage system of claim 12, wherein the groups of data shards are not stored on the first storage node.

15. The storage system of claim 12, wherein the plurality of storage nodes are distributed across multiple chassis of the data storage system.

16. The storage system of claim 12, wherein the processing device is further configured to:
receive a request for a first data shard of a first group of data shards stored on the one storage node;
determine that the first data shard is inaccessible; and
reconstruct the first data shard based on remaining data shards of the first group of data shards and a first group parity shard for the first group of data shards.

17. The storage system of claim 16, wherein to determine that the first data shard is inaccessible the processing device is further configured to:
determine that one storage node of the plurality of storage nodes is inoperable, wherein the first data shard is stored on the one storage node.

18. The storage system of claim 12, wherein the processing device is further configured to:
determine that one or more data shards are inaccessible;
determine whether the one or more data shards can be relocated to the first storage node; and
transmit a message indicating that the one or more data shards can be relocated to the first storage node.

19. The storage system of claim 12, wherein the processing device is further configured to:
recover data shards when one data shard from each group is inaccessible and when one or more additional data shards are inaccessible.

20. A non-transitory, computer-readable media having instructions thereupon which, when executed by a processor, cause the processor to perform a method comprising:
receiving incoming data to be stored in a data storage system comprising a plurality of storage nodes, wherein each storage node comprises a plurality of non-volatile memory modules; and
storing the incoming data in a redundant array of independent drives (RAID) stripe in the data storage system, wherein:
the RAID stripe comprises groups of data shards;
each group of data shards and a respective group parity shard are stored across the plurality of nodes of the data storage system; and
a set of stripe parity shards are stored in a first storage node of the plurality of storage nodes.
